(19) United States
(12) Patent Application Publication
(10) Pub. No.: US 2004/0261731 A1
(43) Pub. Date: Dec. 30, 2004

(54) Rotary engine and compressor

(76) Inventor: Hojjat Fathollahi, Tehran (IR)

Correspondence Address: Mr. ALI MANSOURY, 8308 MARINER COURT, GAITHERSBURG, MD, 20882, US

(21) Appl. No.: 10/606,898

(22) Filed: Jun. 27, 2003

(51) Int. Cl. F02B 57/00

(52) U.S. Cl. 123/43 R

(57) ABSTRACT

An internal combustion rotary engine comprising a casing, end covers and a rotor including a number of chambers, an output shaft as the rotor axis, planet gears each mounted on a small shaft which is a part of planet gear fixing support and the supports being fixed on one or both side(s) of the rotor, rotationally reciprocating pistons in piston chambers, piston pins as the axes of rotation of the pistons and piston rods connecting the pistons to planet gears.

This rotary engine is characterized by the ignition force causing a piston to rotate around its axis and pulling the piston rod and the piston rod causing a planet gear to rotate around its axis. The planet gears mesh with a sun gear(s) fixed to the engine block on one or both side(s) of the casing. The rotation of each planet gear makes the planet gear move on the sun gear and this makes the rotor shaft rotate.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

This invention is related to any engineering field wherein an internal combustion engine can be used to drive a system, such as automotive engineering and aircraft engineering, or wherein a compressor can be used to compress a fluid.

### HISTORY OF INVENTIONS IN INTERNAL COMBUSTION ENGINES

The first internal-combustion engine was designed by the Dutch scientist Christian Huygens in 1678 and was to be fueled with gunpowder, but it was never built. In about 1860 a French inventor, Etienne Lenoir, built the first practical internal-combustion engine which burned illuminating gas. In 1866 two German engineers, Eugen Langen and Nikolaus August Otto, developed a more efficient gasoline engine, and in 1876 Otto built a four-cycle engine, a prototype of the so-called Otto-cycle engines used in most modem automobiles and airplanes.

Rotary engines were known as early as 1588, following the development of a rotary engine design by Ramelli. Various rotary engine designs were proposed during the late 1800's following the development of the four stroke Otto cycle engine in 1876. Rotary engine designs enjoyed popularity in aviation applications at the time of World War I. These engines were primarily air-cooled, with cylinders arranged radially around a crankshaft that was fastened to the fuselage.

The most successful rotary engine has been the Wankel engine developed by the German engineer Felix Wankel in 1956 Following Wankel's development of various rotary engines, Curtiss-Wright licensed rotary engine technology from Wankel GmbH in 1958. Curtiss-Wright began an aggressive research program into the various applications of rotary engines, including automotive and other applications. Curtiss-Wright, however, did not develop a commercially viable rotary engine. Instead, in 1984, Curtiss-Wright sold its rotary engine division to John Deere. Deere proceeded to do additional research on stratified charge, rotary engines.

Numerous engine manufacturers and automotive companies have attempted to develop commercial rotary engines including: Curtiss Wright, John Deere, Rotary Power International, Mazda, NSU (Germany), Audi, General Motors, Ford, and Nissan. With the exception of Mazda, each has tried and failed to achieve a commercially successful rotary engine.

Till now many kinds of engines have been invented, but from a commercial point of view, the absolute majority of engine usage is with conventional reciprocating internal combustion engines in comparison with any type of rotary internal combustion engine.

### OBJECTS OF THE INVENTION

It is an object of a preferred embodiment of the present invention to achieve a new rotary engine design, wherein the engine based on this concept be able to compete with conventional reciprocating engines from a commercial point of view.

It is an object of a preferred embodiment of the present invention to provide a new rotary engine design for achieving lower engine cost in comparison with the Wankel engine.

It is an object of a preferred embodiment of the present invention to provide a new rotary engine design to improve sealing and lubrication in the areas of the inner surface of the casing and the outer surface of the rotor.

It is an object of a preferred embodiment of the present invention to provide a new rotary engine of small size.

It is an object of a preferred embodiment of the present invention to provide a new rotary engine of light weight.

It is an object of a preferred embodiment of the present invention to provide a new rotary engine design to improve engine power in comparison with conventional reciprocating four-stroke internal combustion engines.

It is an object of a preferred embodiment of the present invention to provide a new rotary engine design to improve engine torque in comparison with conventional reciprocating four-stroke internal combustion engines.

It is an object of a preferred embodiment of the present invention to provide a new rotary engine design of low complexity.

It is an object of a preferred embodiment of the present invention to provide a new rotary engine design with ease of manufacturing.

It is an object of a preferred embodiment of the present invention to provide a new rotary engine design with ease of assembly.

It is an object of a preferred embodiment of the present invention to provide a new rotary engine design with a statically balanced rotor.

It is an object of a preferred embodiment of the present invention to provide a new rotary engine design with a dynamically balanced rotor.

### SUMMARY OF THE INVENTION

An internal combustion rotary engine comprising: a casing defining a cylindrical chamber, end covers that support the main engine shaft and are securely fixed on the casing, a rotor with an output shaft as the main engine shaft in the said cylindrical chamber, piston chambers and rotationally reciprocating pistons in the rotor, planet gears on the rotor that rotate around their own axes as well as the main shaft axis where the said planet gears also play the role of a reciprocating engine crank shaft in said new rotary engine, piston rods that connect pistons to planet gears where the planet gears are mating with a sun gear(s) fixed to the engine block on one or both side(s) of the casing. The rotation of the planet gears around their axes at combustion stroke causes them to move on the sun gear and causes the rotor to rotate around its shaft axis.

### BRIEF DESCRIPTION OF THE DRAWINGS

All figures pertain to a rotary engine with n=1 (n is the number of complete working strokes per revolution of the main shaft for each piston), plant gears mounted on one side of the rotor; and the engine comprises: rotor assembly, casing assembly, right hand end cover assembly and left hand end cover assembly Dimensions of all components are comparable with each other, except for the zoomed views.

Table 1 shows the engine parts list including part numbers for all engine assemblies, subassemblies and components.

FIG. 1a and 1b show complete assembly of the engine.

FIG. 2 shows a cutaway drawing of the rotary engine.

FIGS. 3a and 3b show complete assembly of the rotor.

FIGS. 4a and 4b show the right hand end cover assembly.

FIGS. 5a and 5b show the left hand end cover assembly.

FIGS. 6a and 6b show the casing assembly.

FIG. 7 shows an exploded view of the rotor assembly.

FIG. 8 shows an exploded view of the right hand end cover assembly.

FIG. 9 shows an exploded view of the left hand end cover assembly.

FIG. 10 shows an exploded view of the casing assembly.

FIGS. 11 through 48 show the rotor assembly components separately.

FIGS. 49 through 57 show the casing assembly components separately.

FIGS. 58 through 62 show the left hand end cover assembly components separately.

FIGS. 63 and 64 show the right hand end cover assembly components separately.

FIGS. 65 through 73 show how the rotary engine works.

FIGS. 74 through 81 show cross sections of the engine.

FIGS. 82 through 87 show more-detailed views of the piston front and the piston side seals and the seal seats on the piston head.

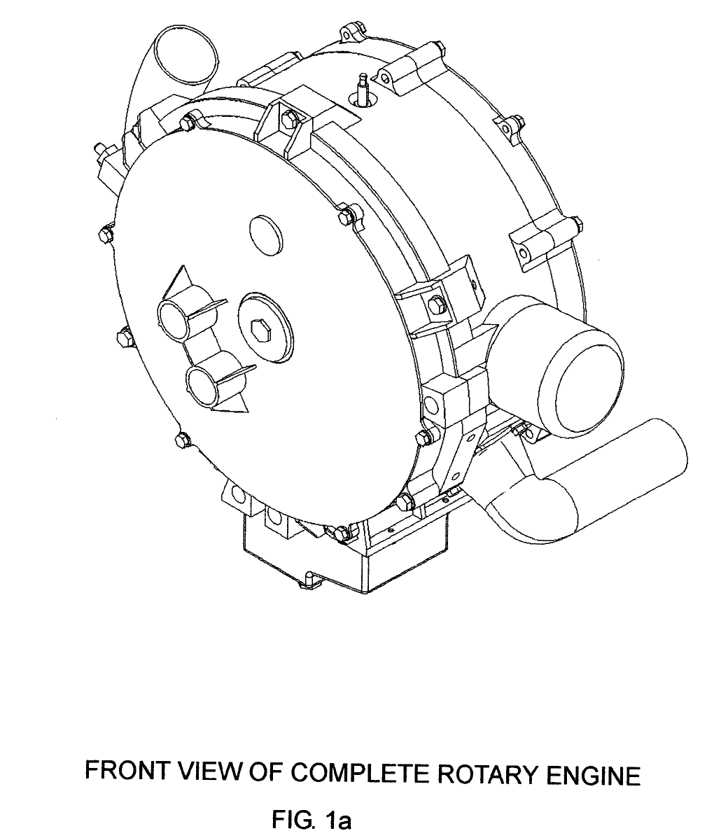

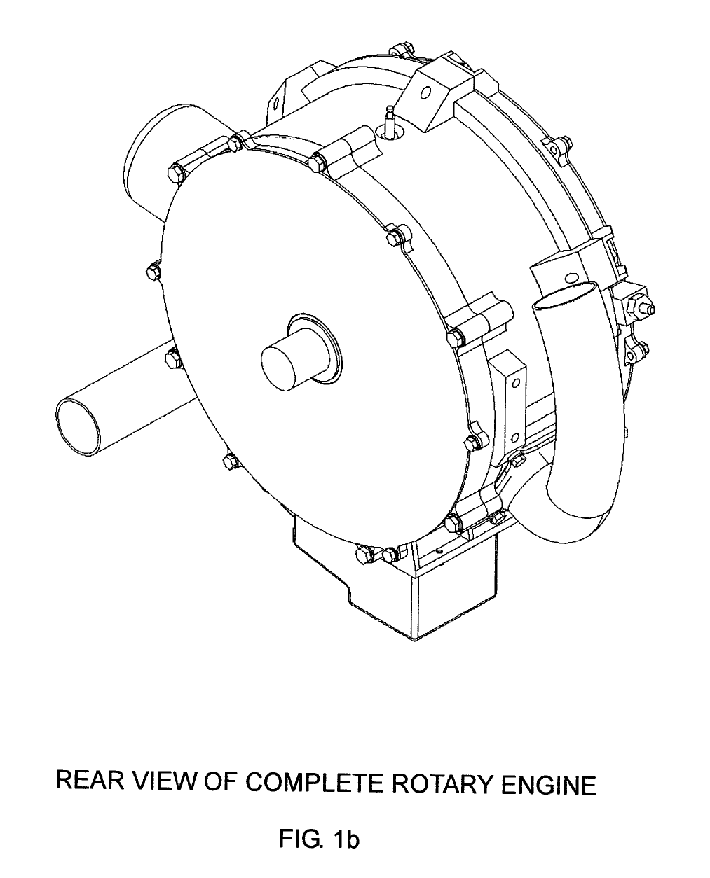

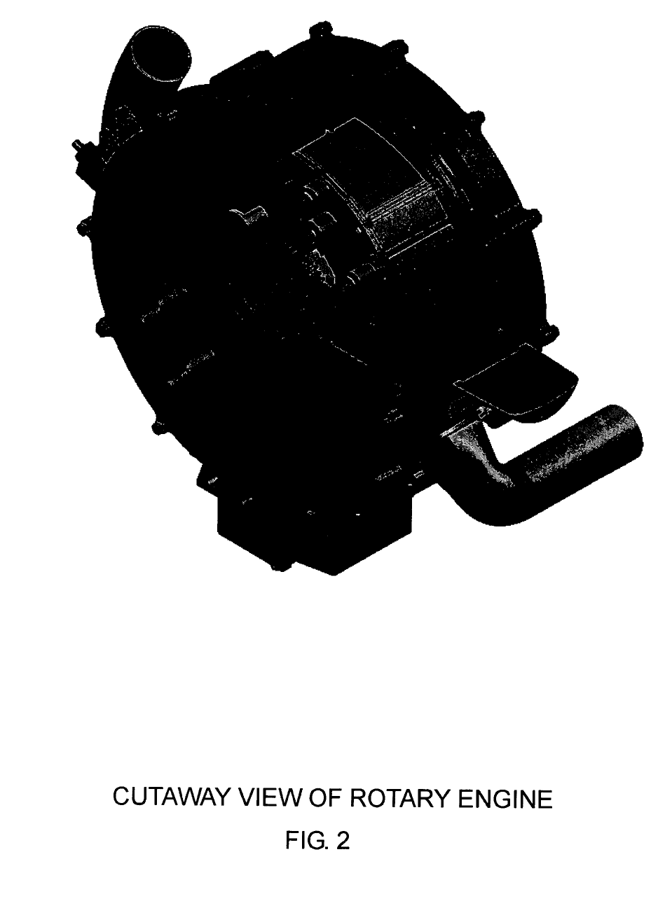

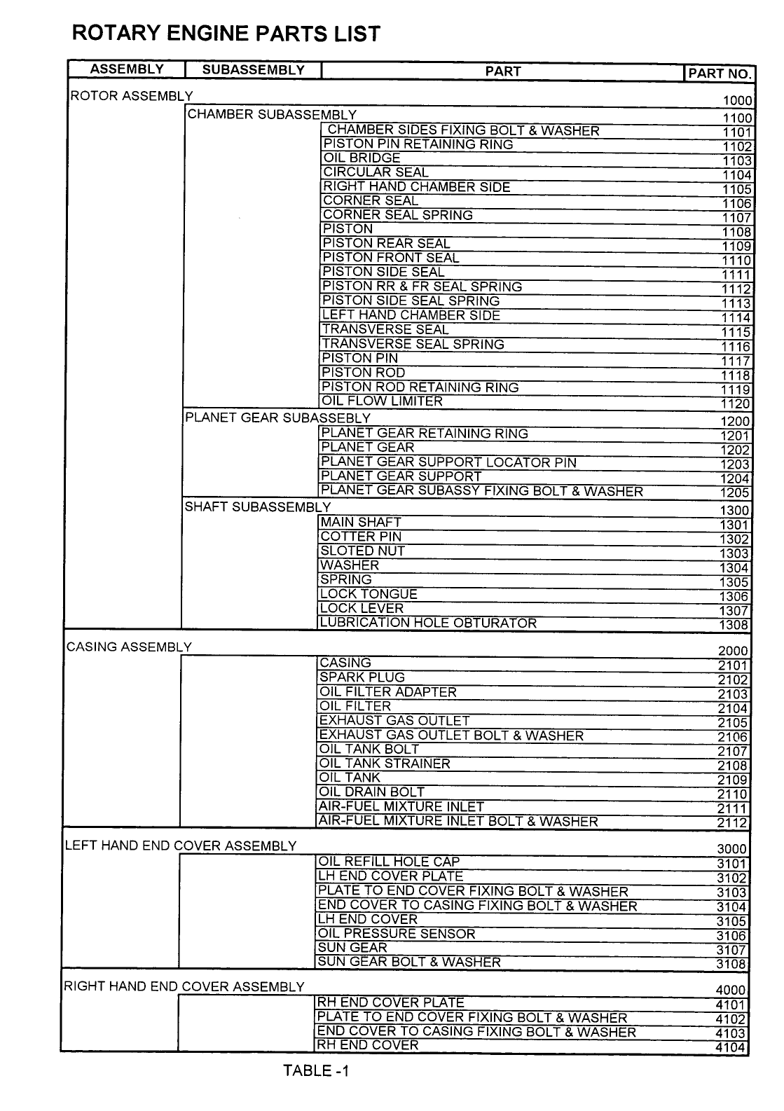

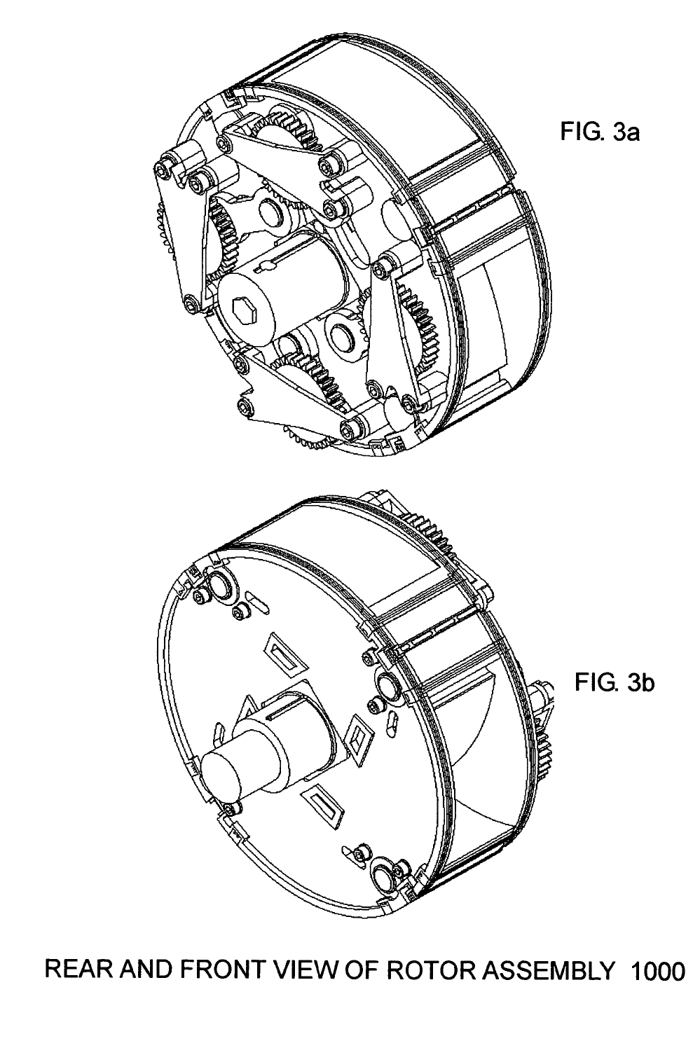

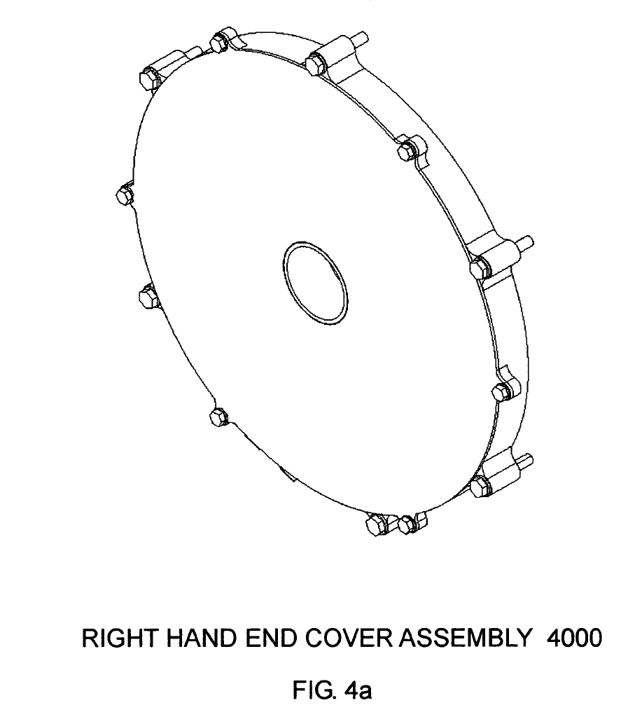

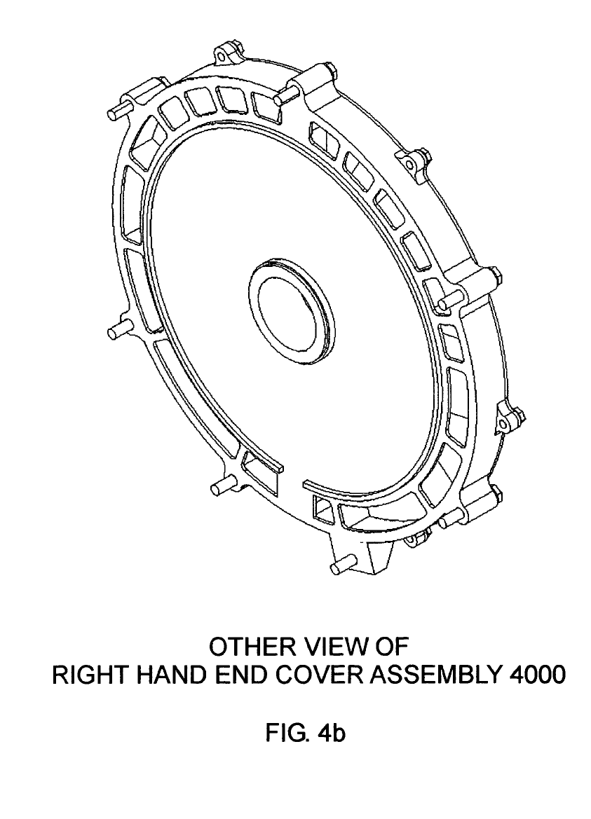

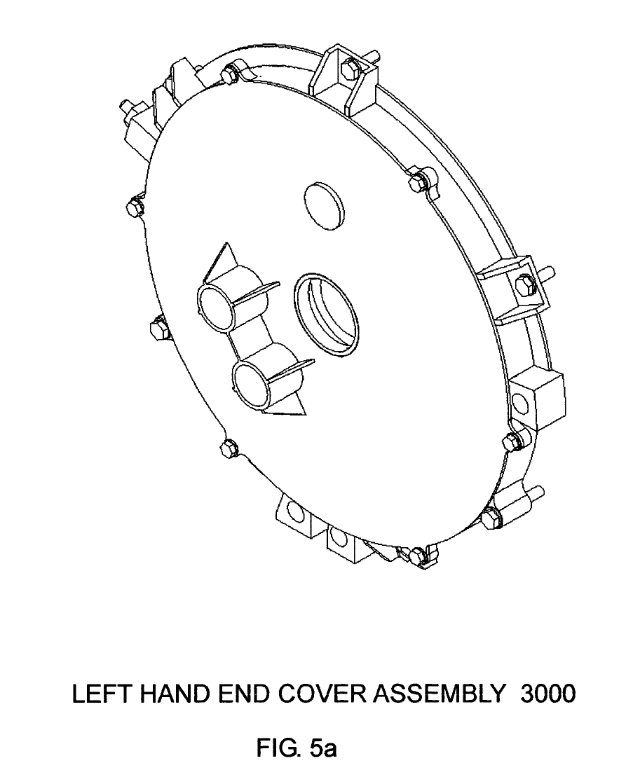

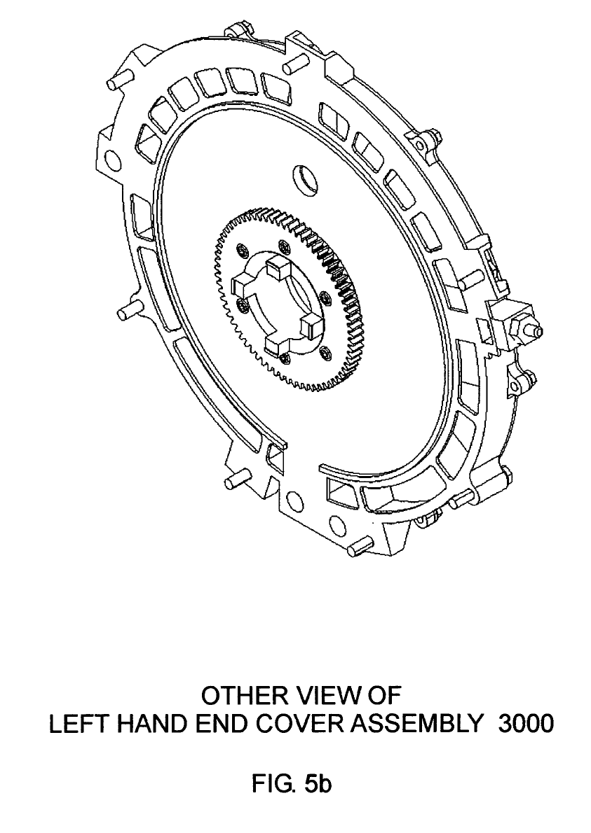

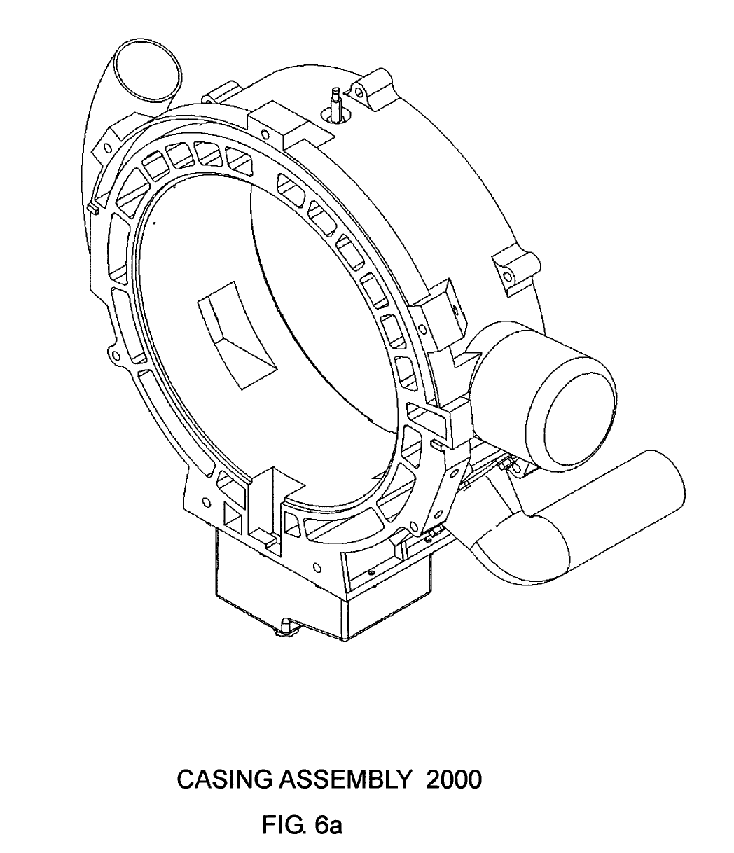

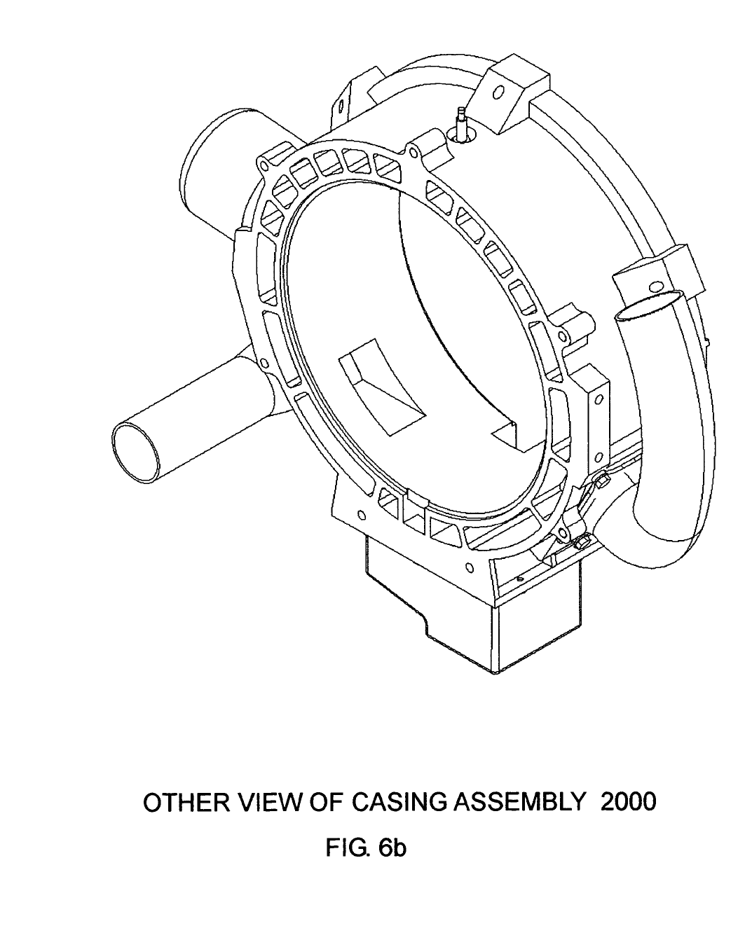

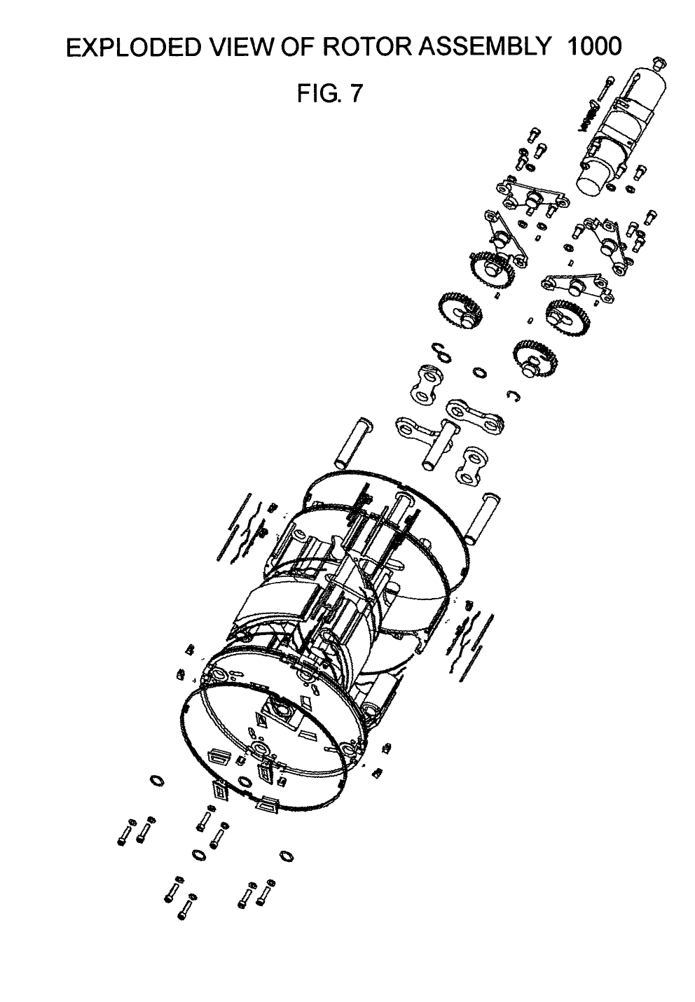

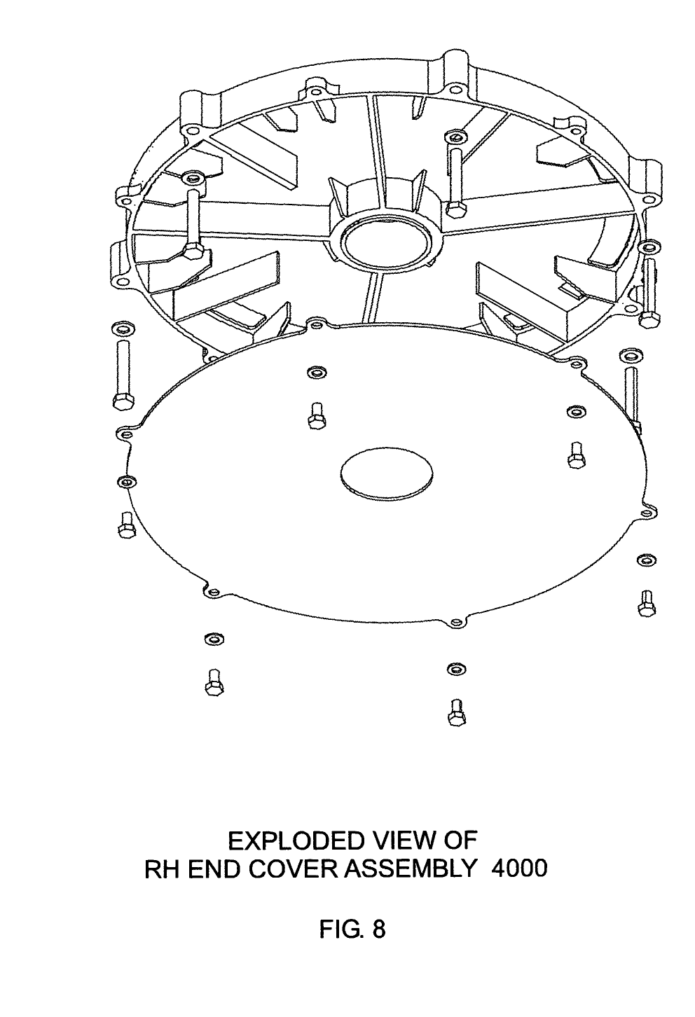

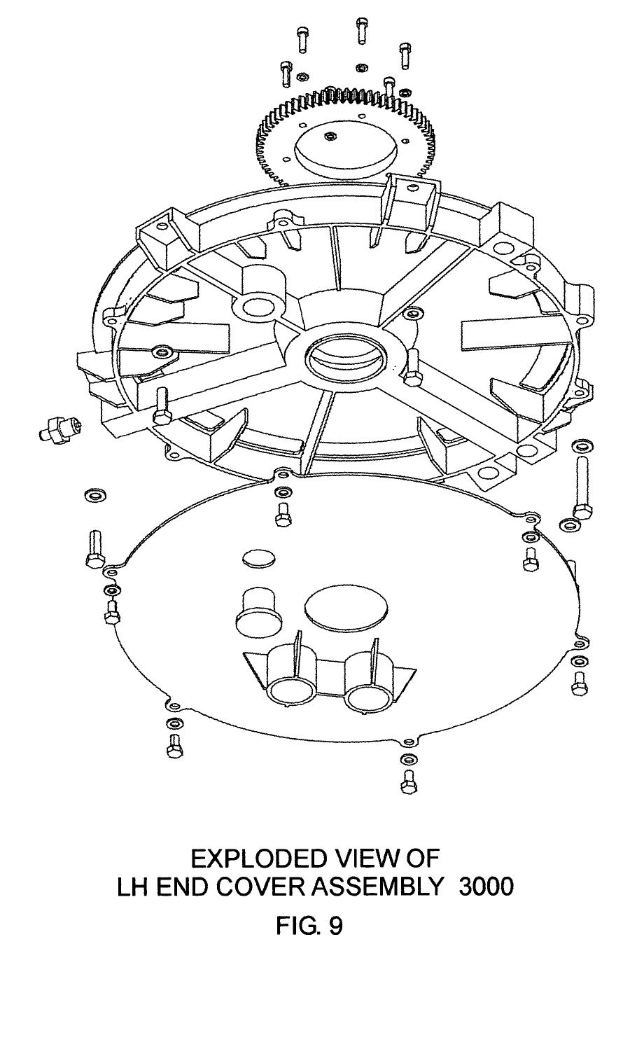

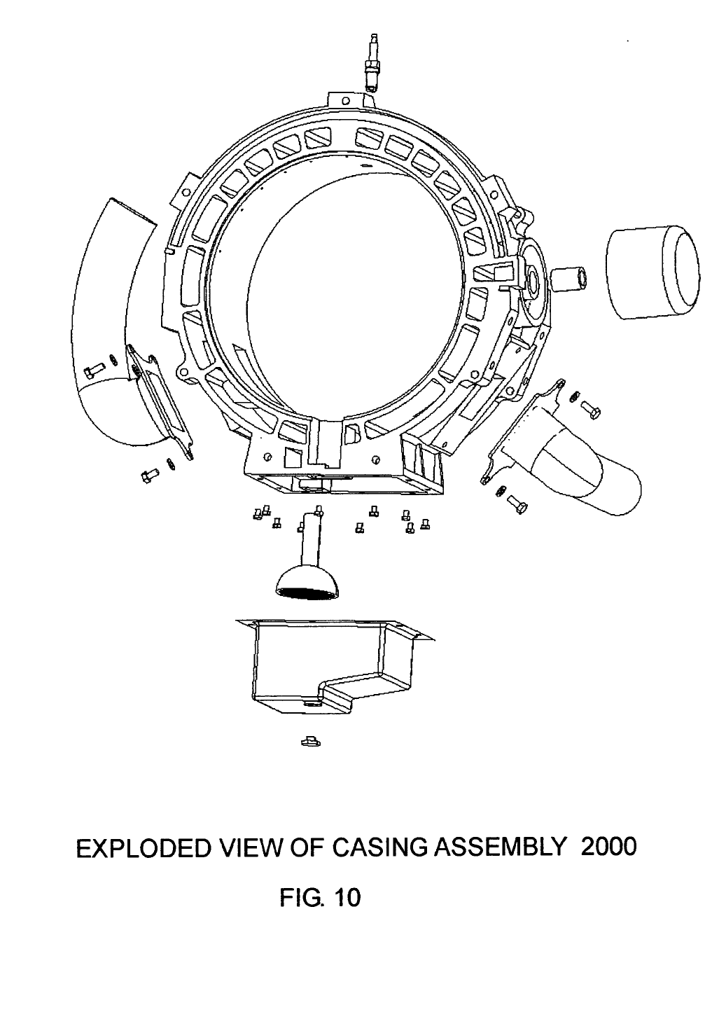

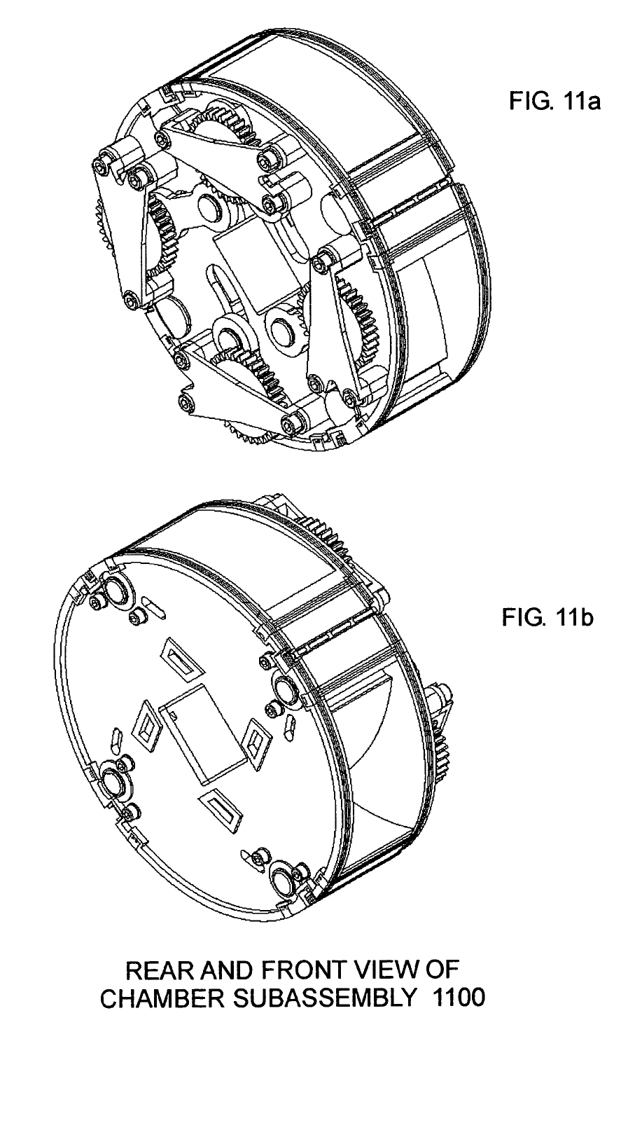

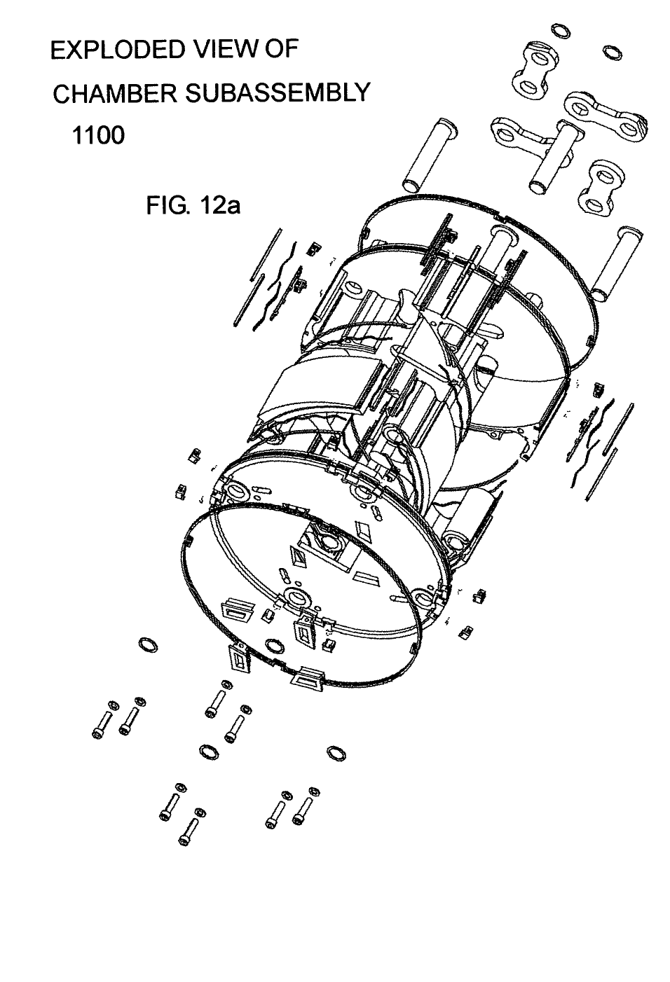

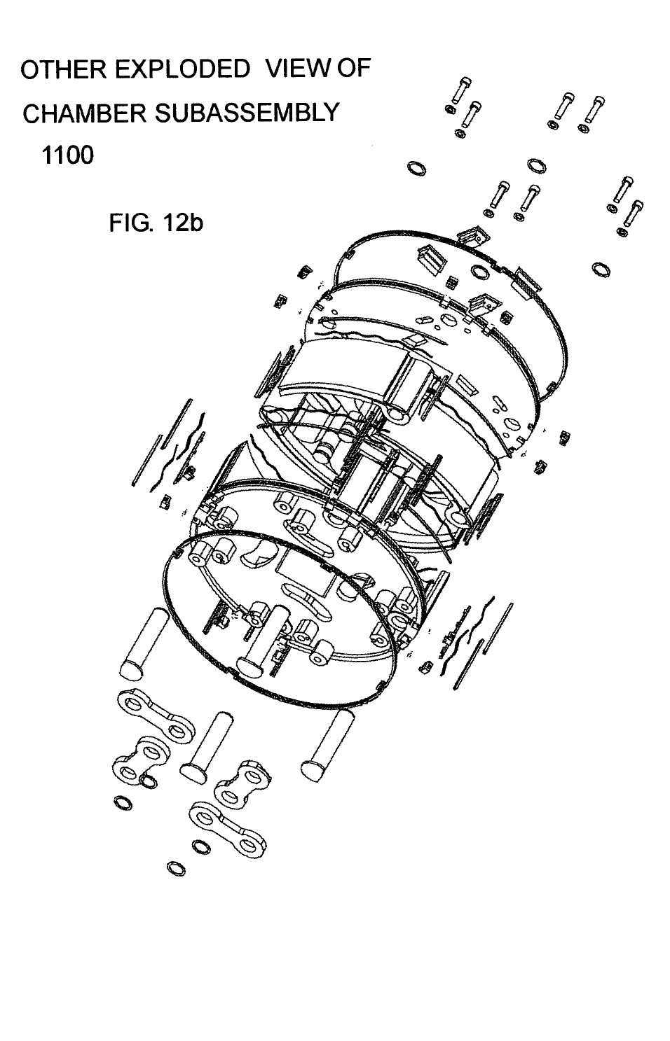

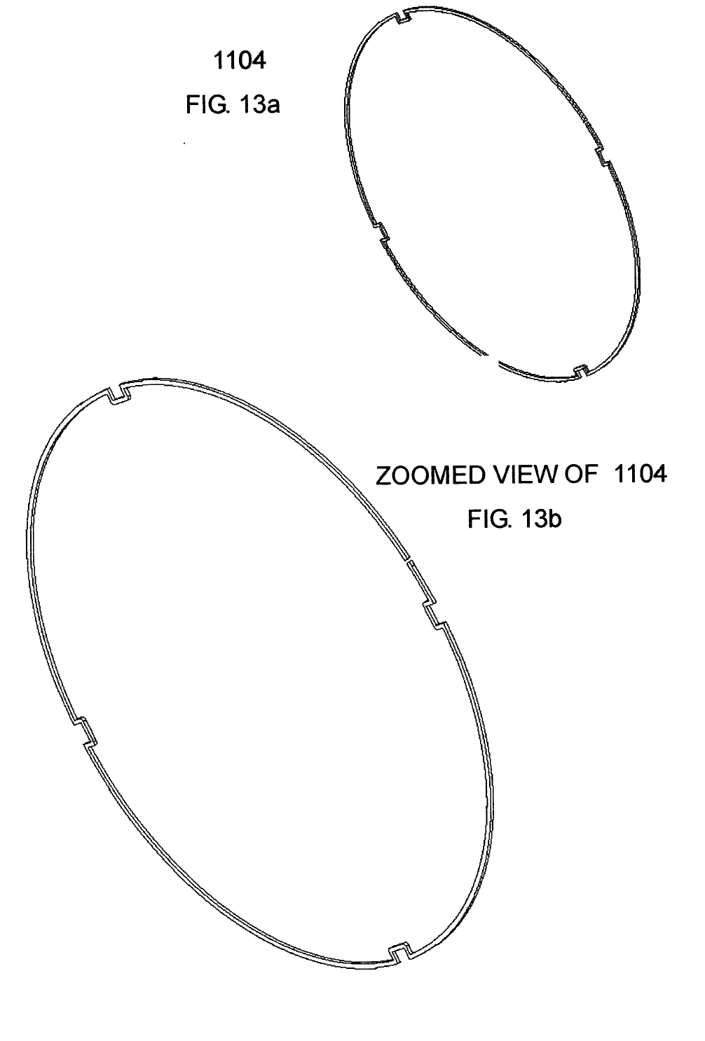

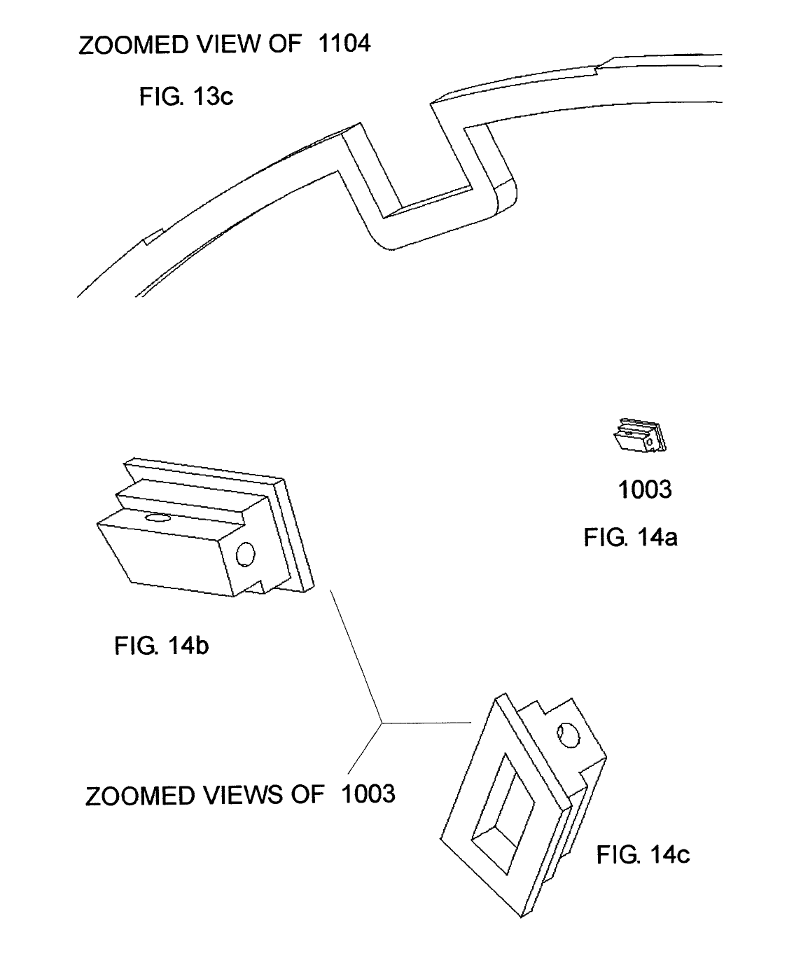

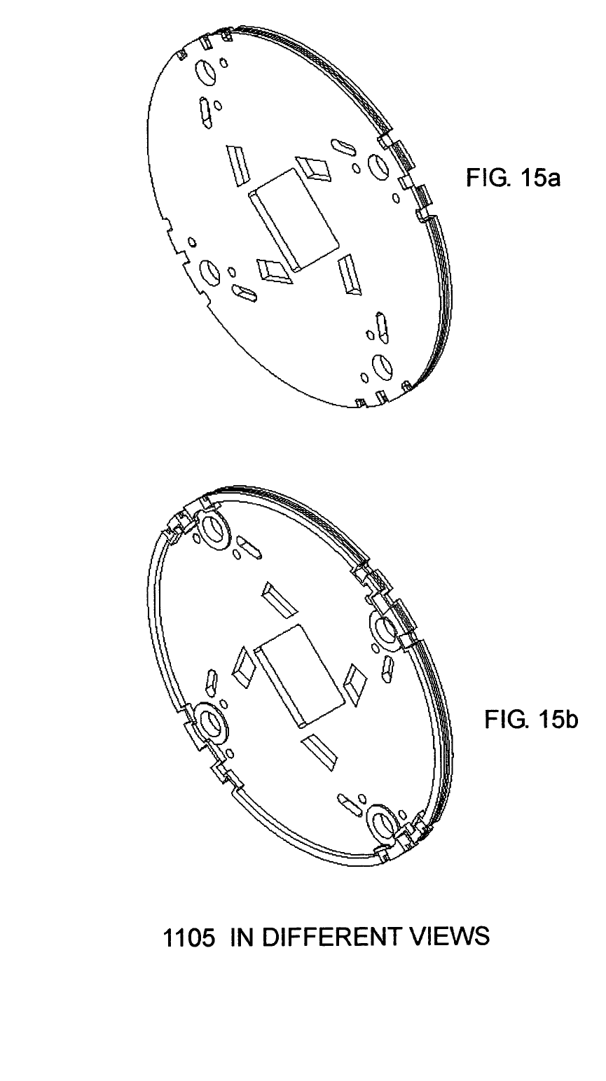

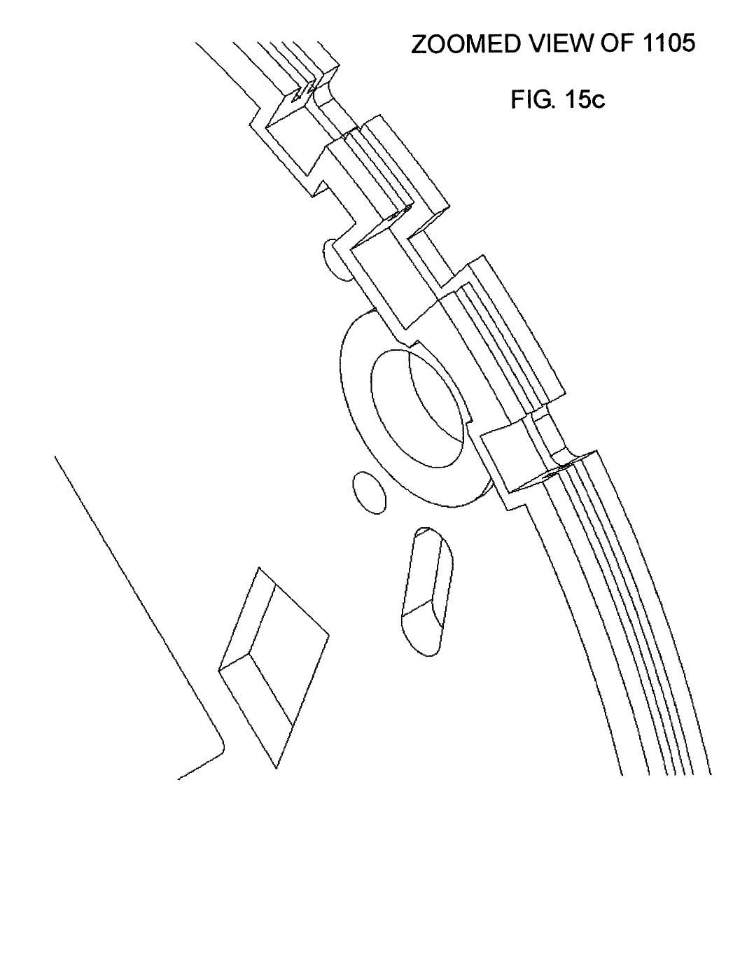

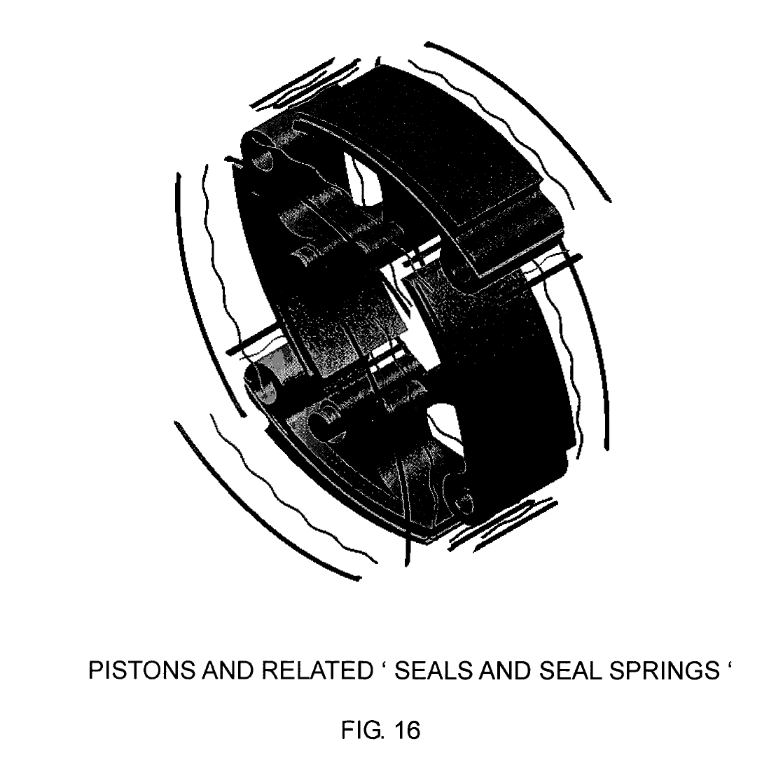

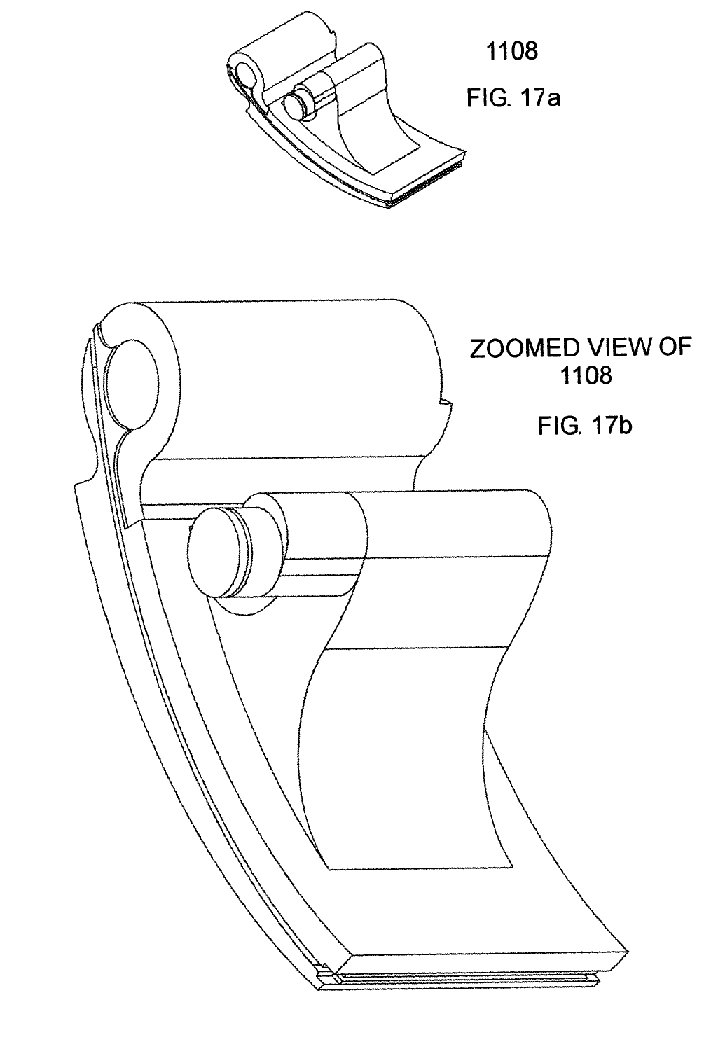

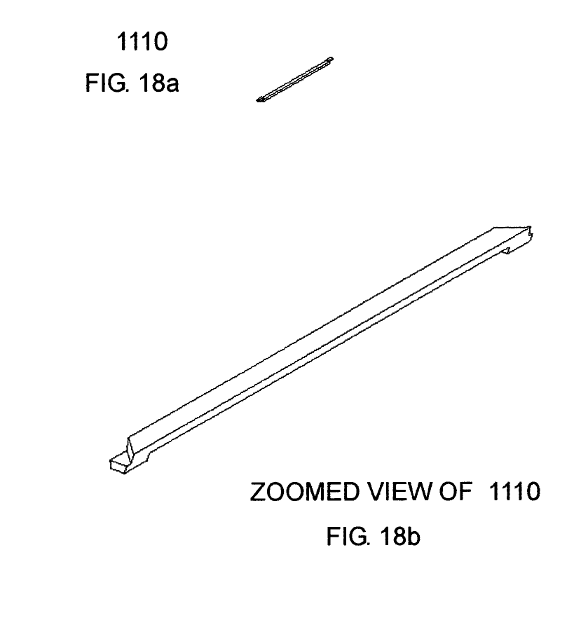

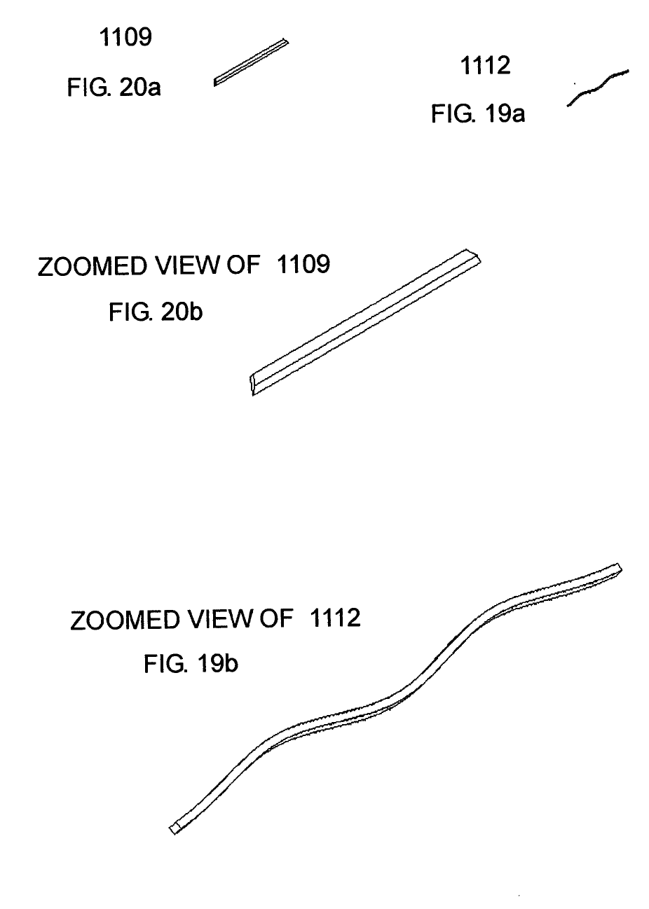

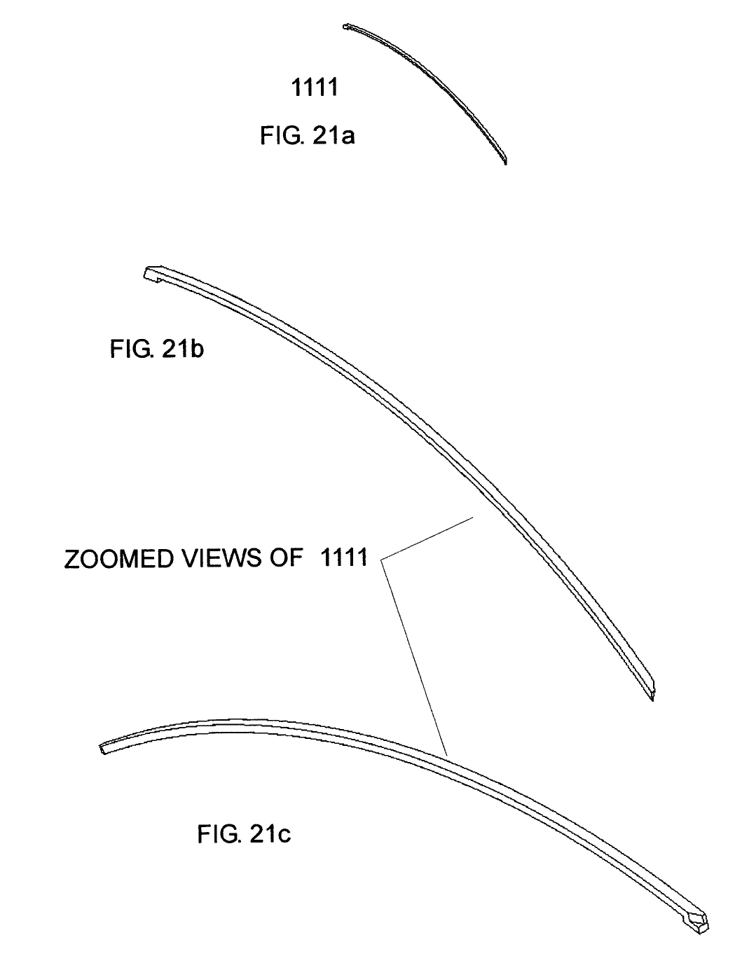

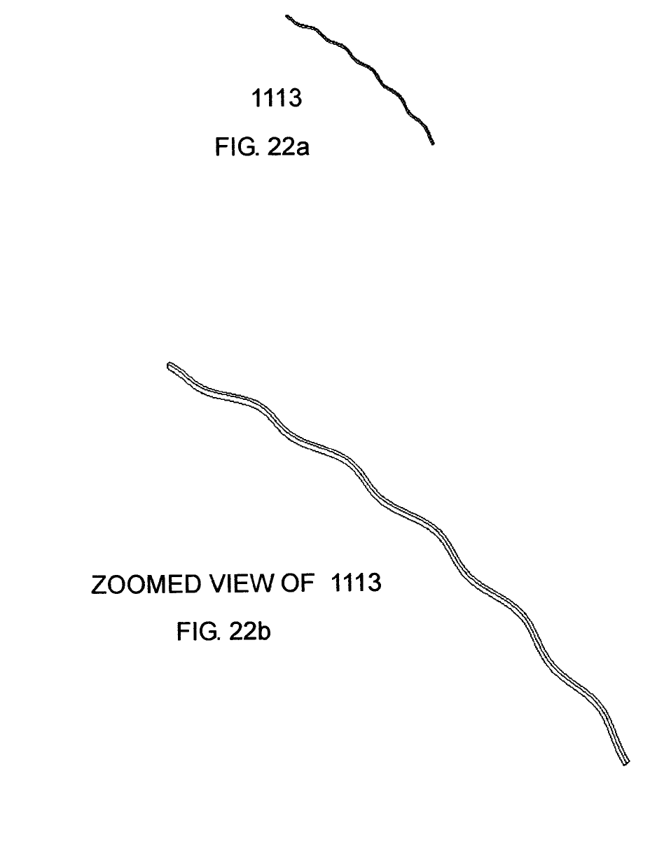

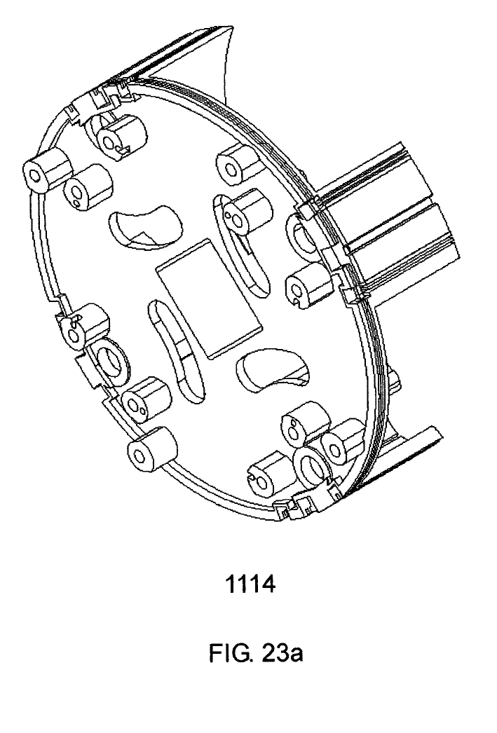

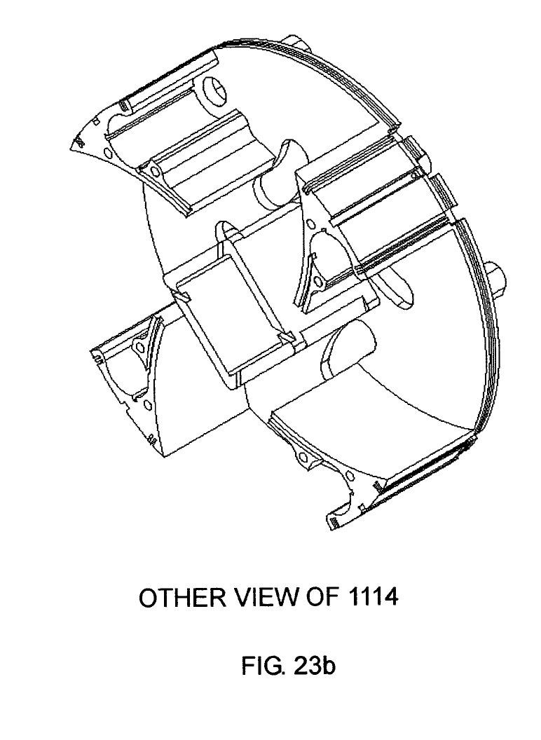

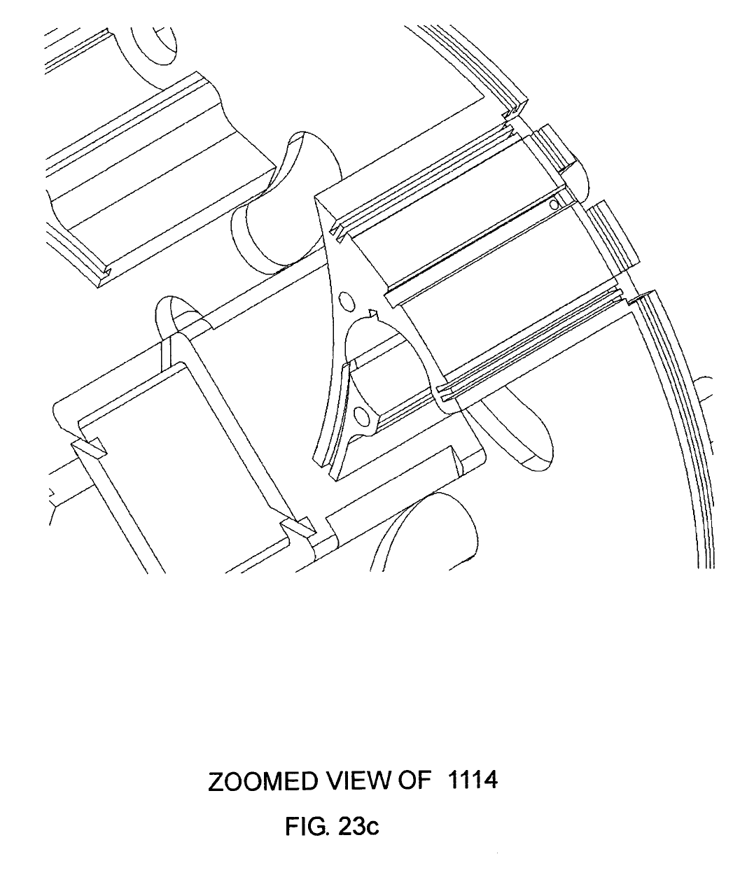

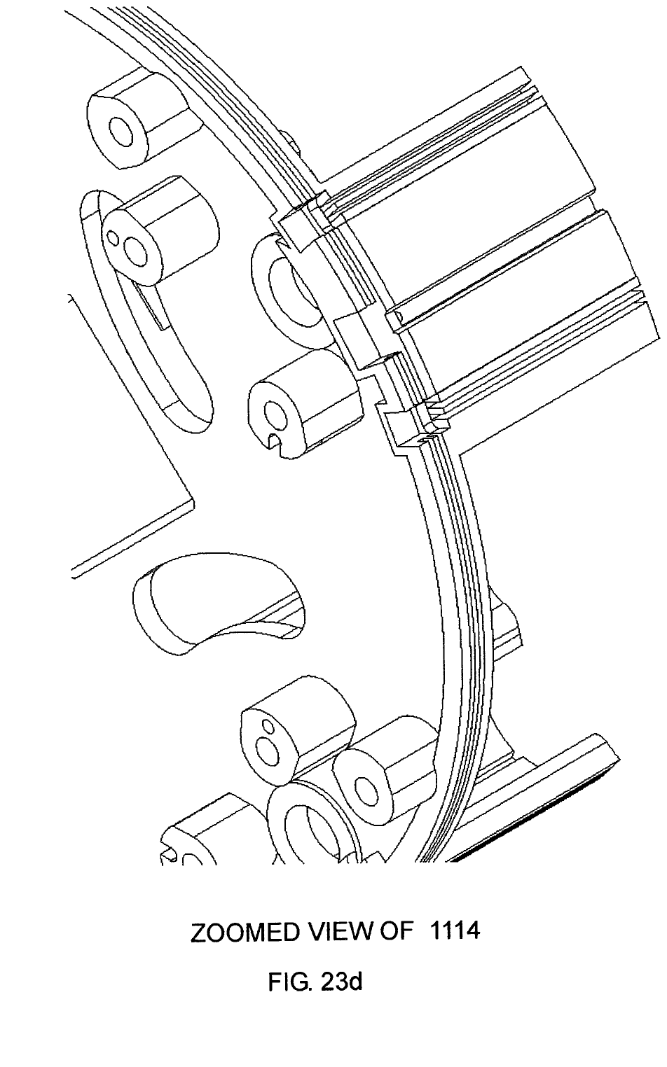

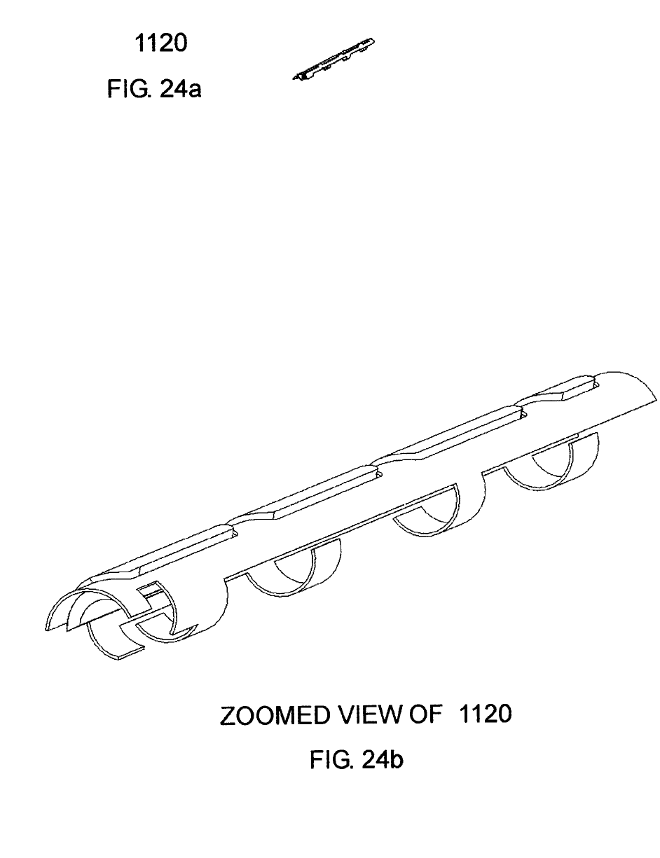

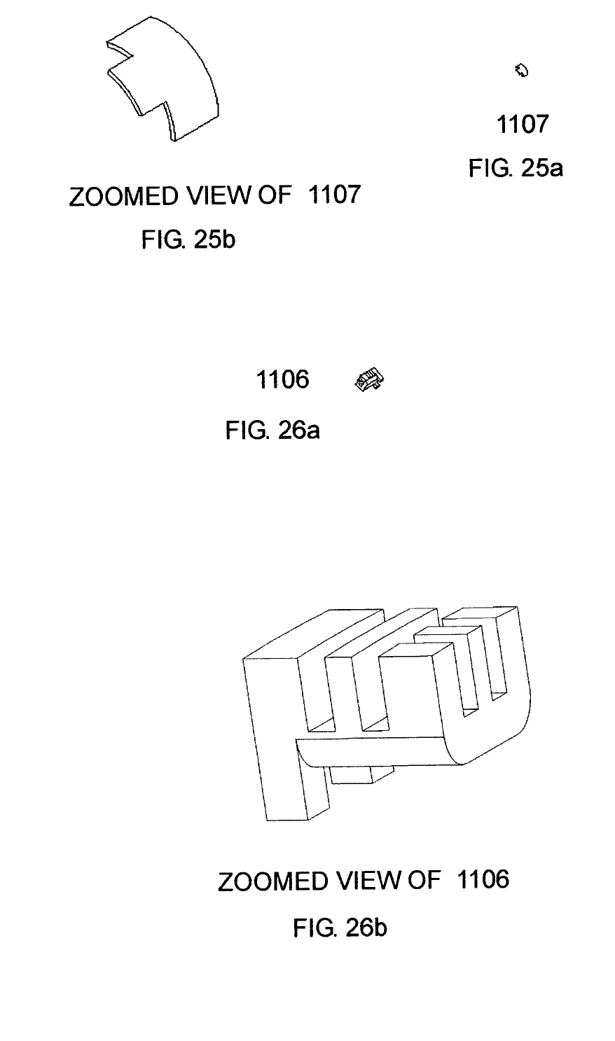

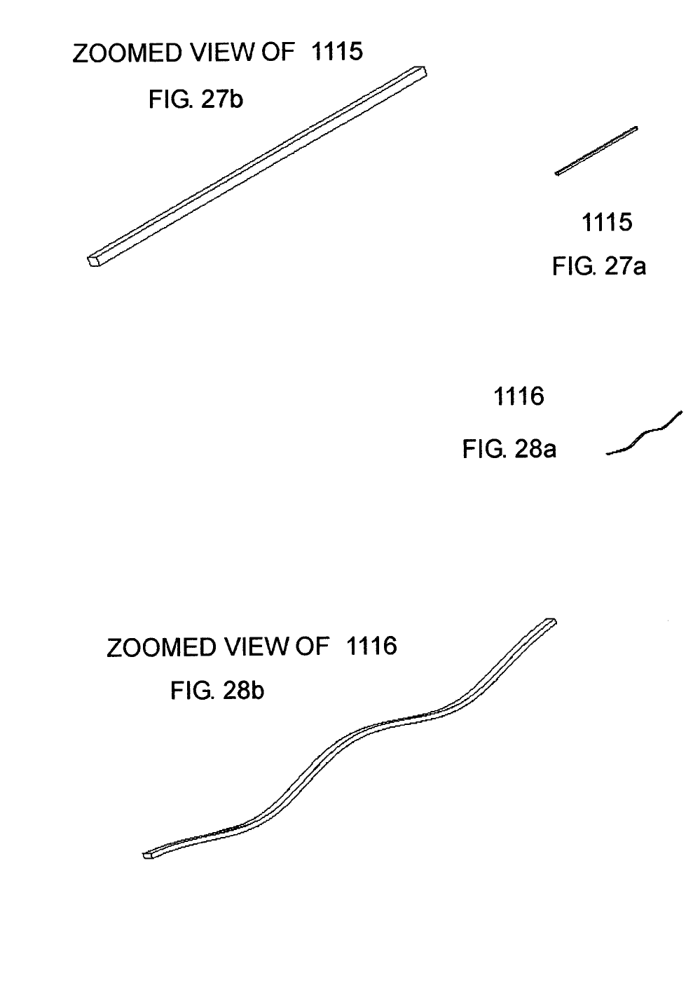

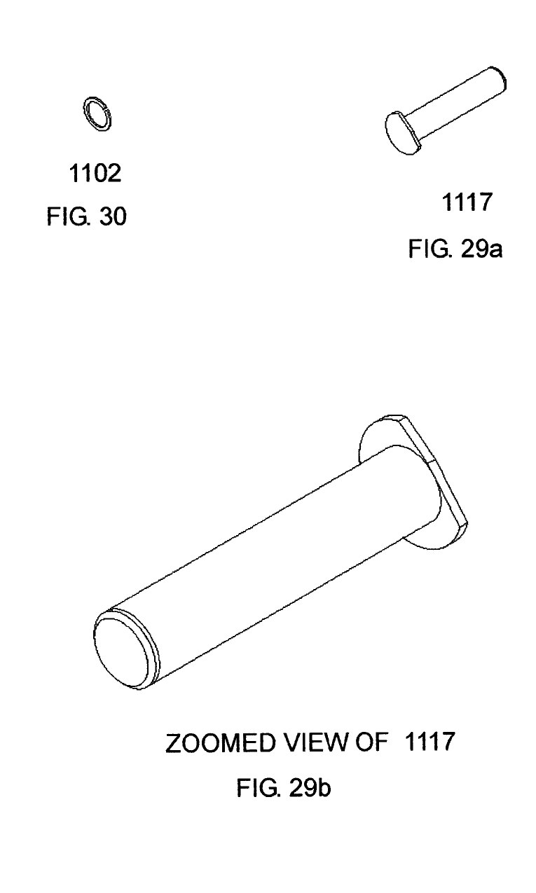

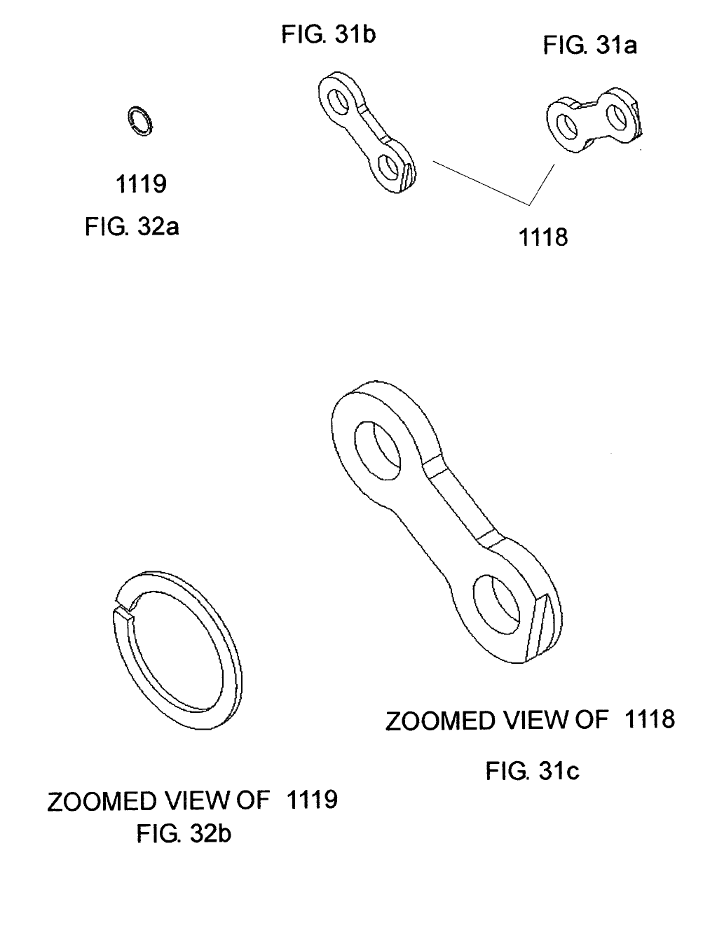

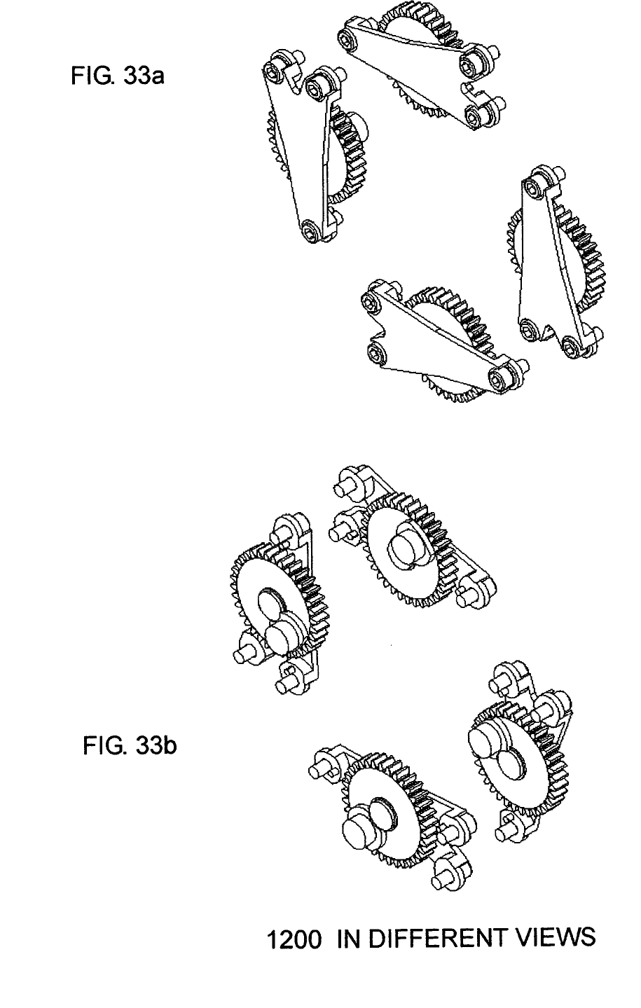

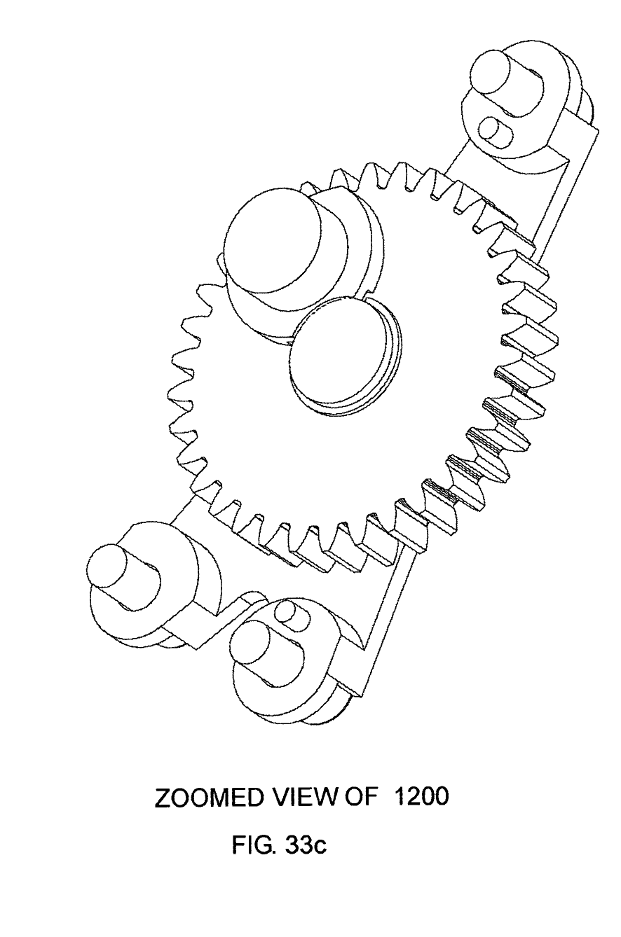

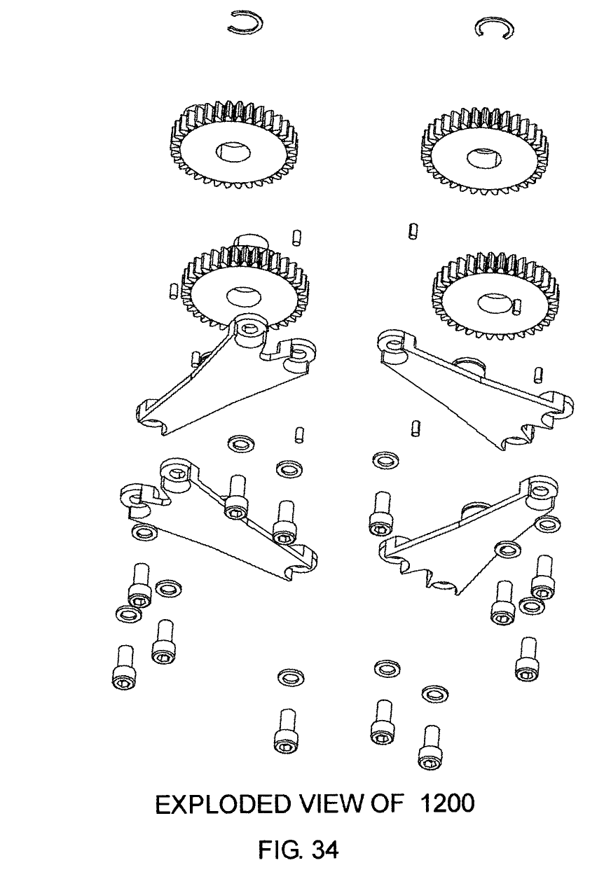

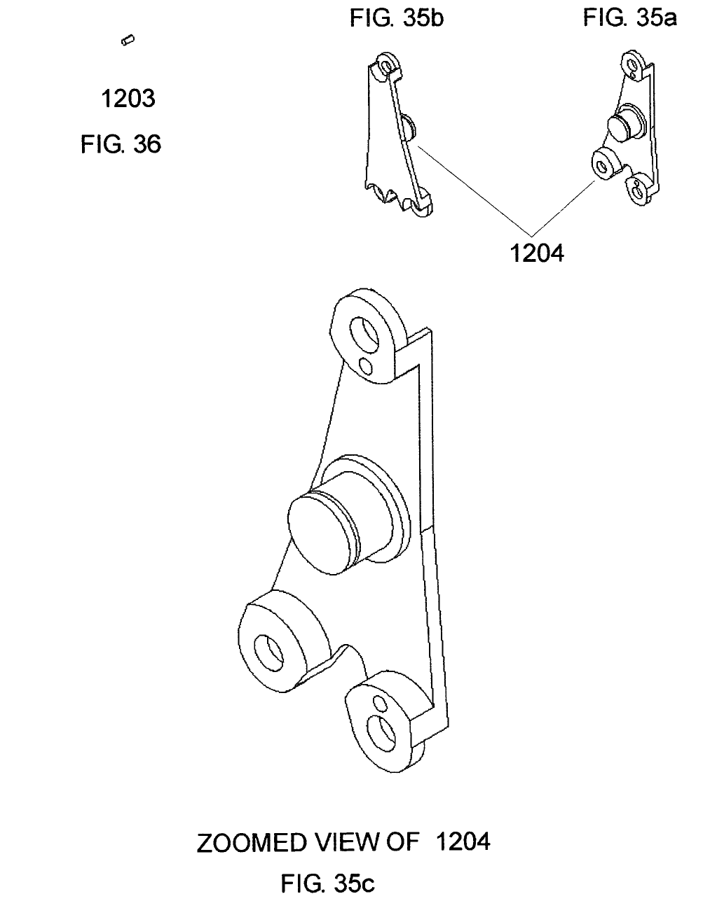

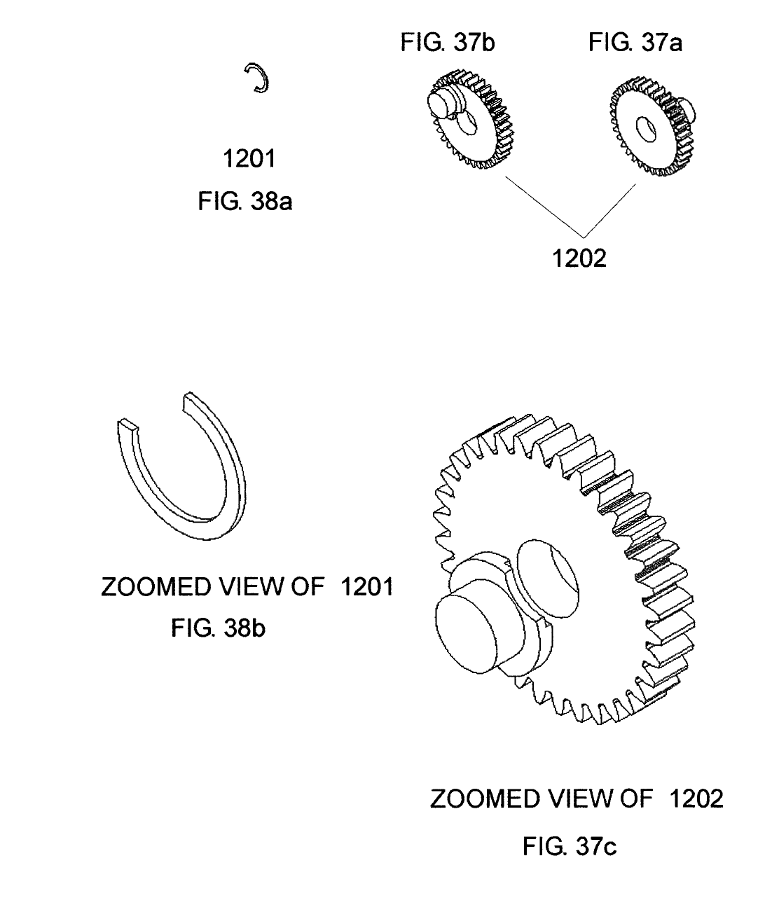

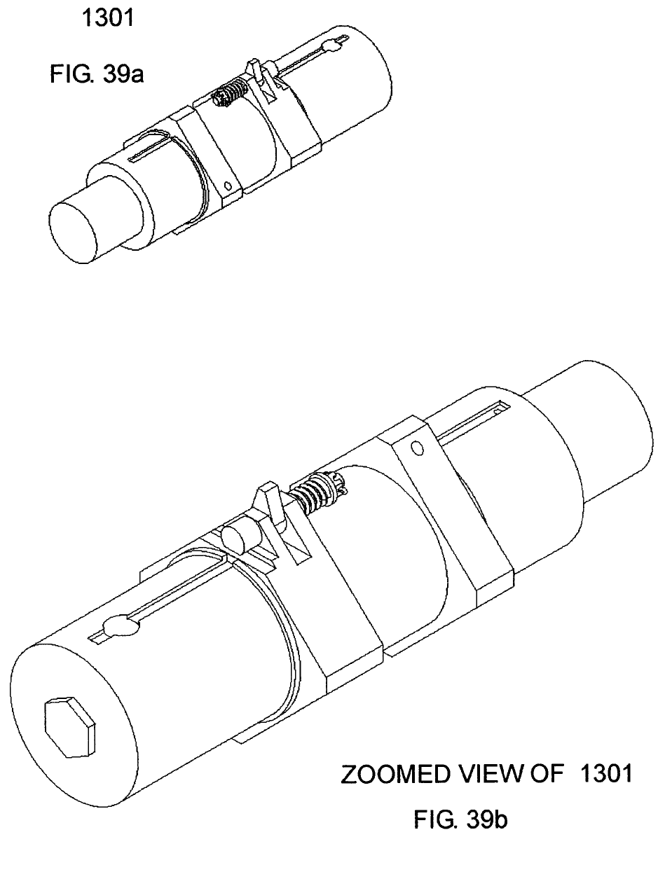

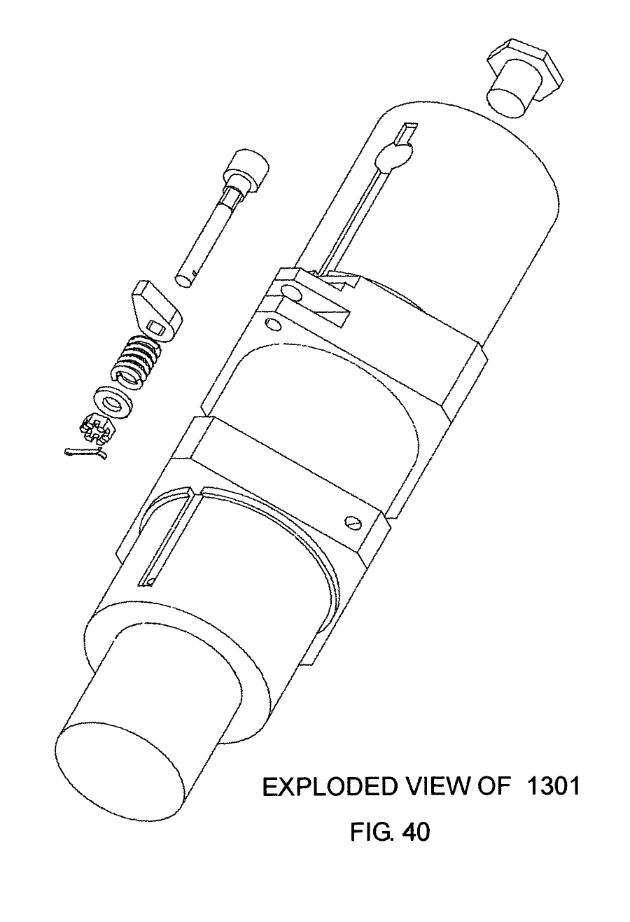

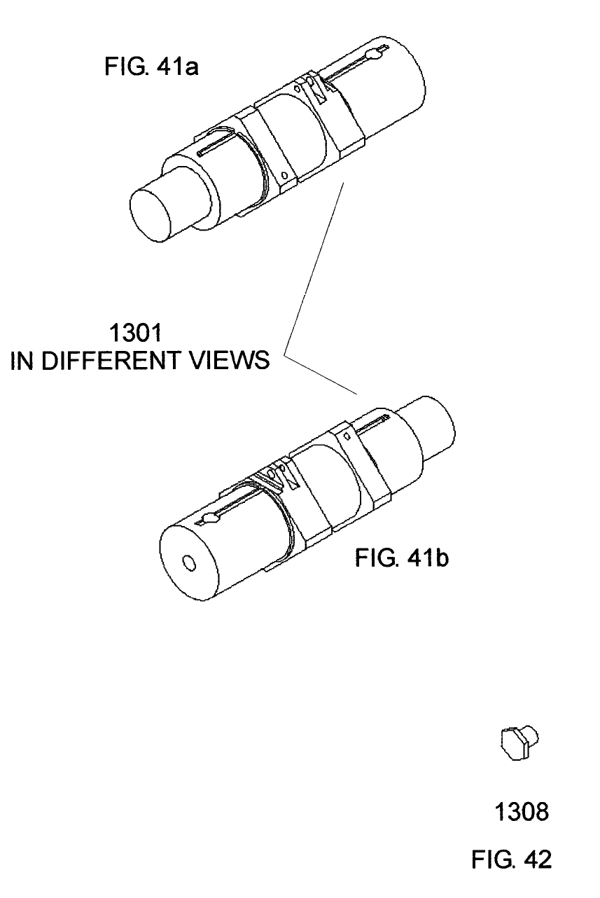

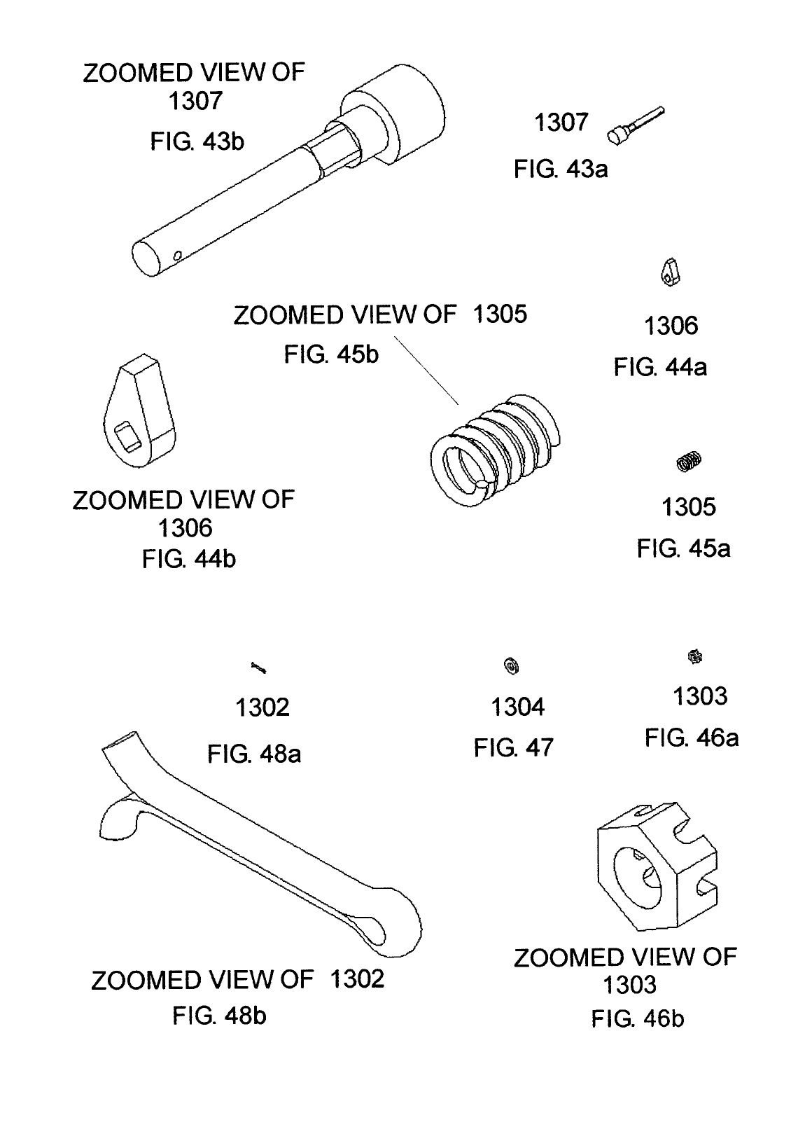

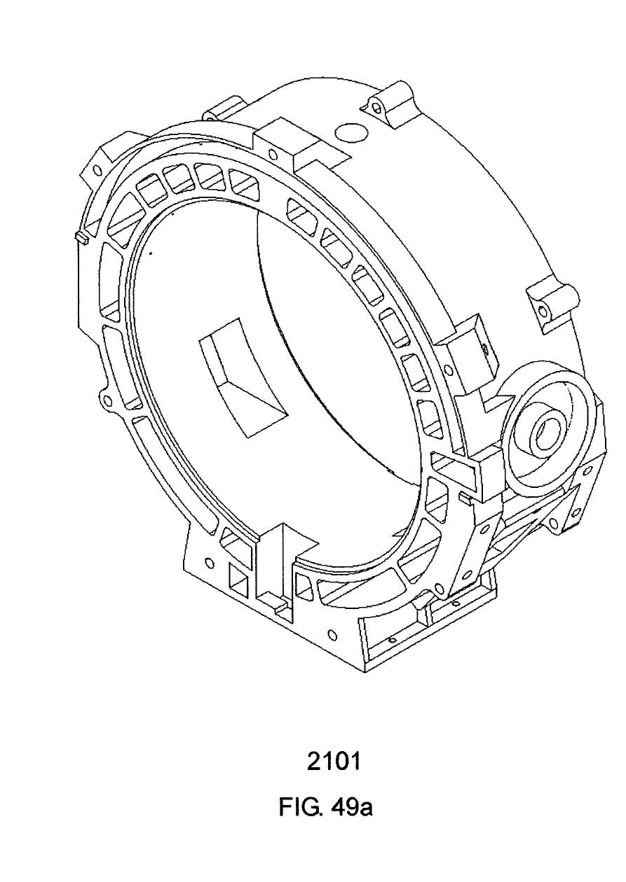

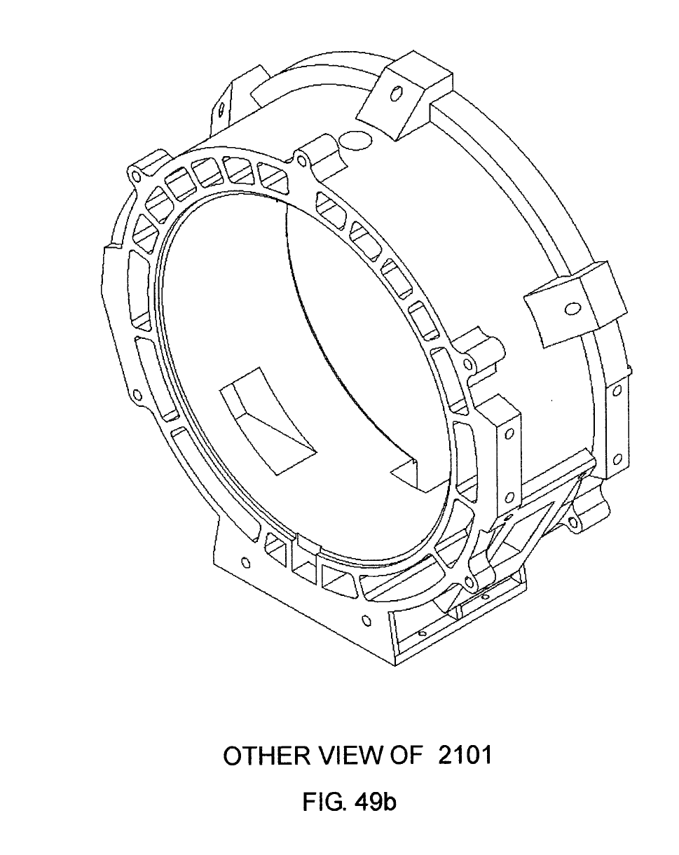

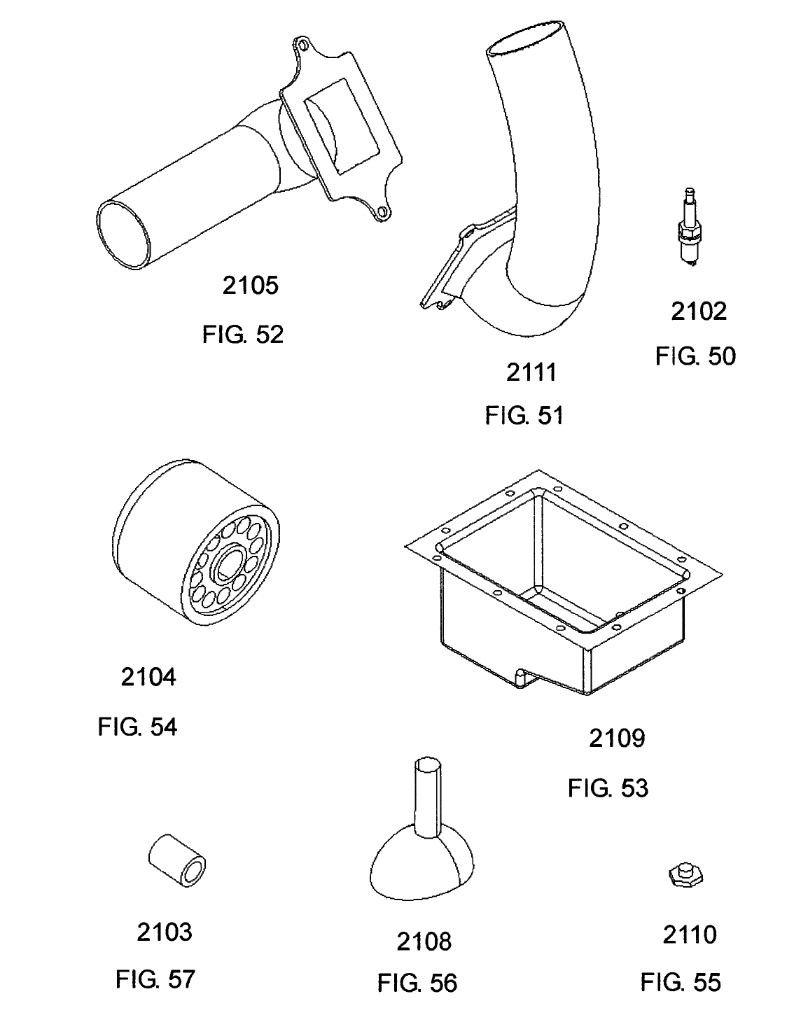

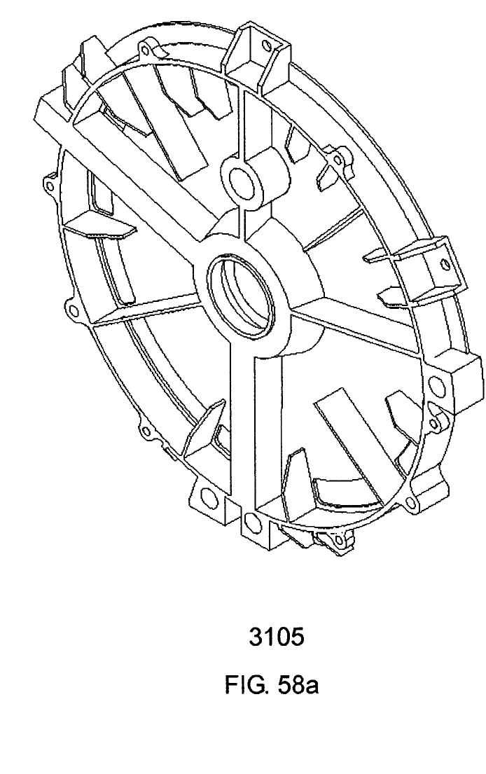

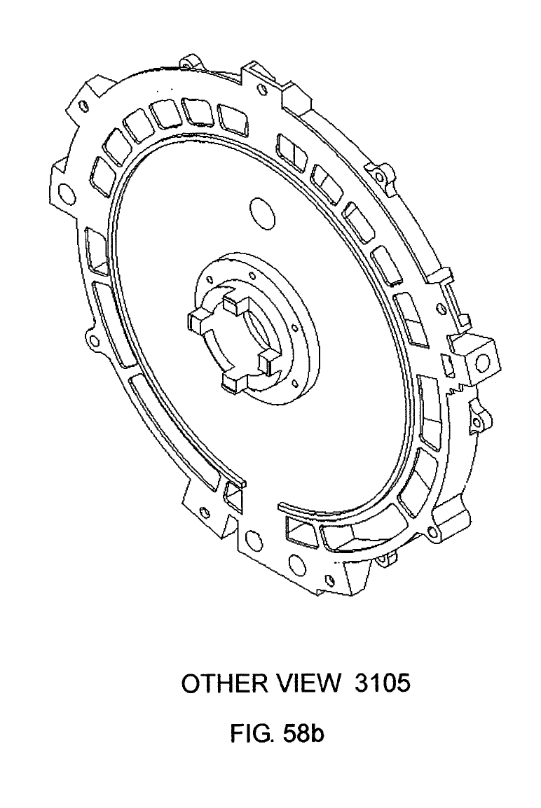

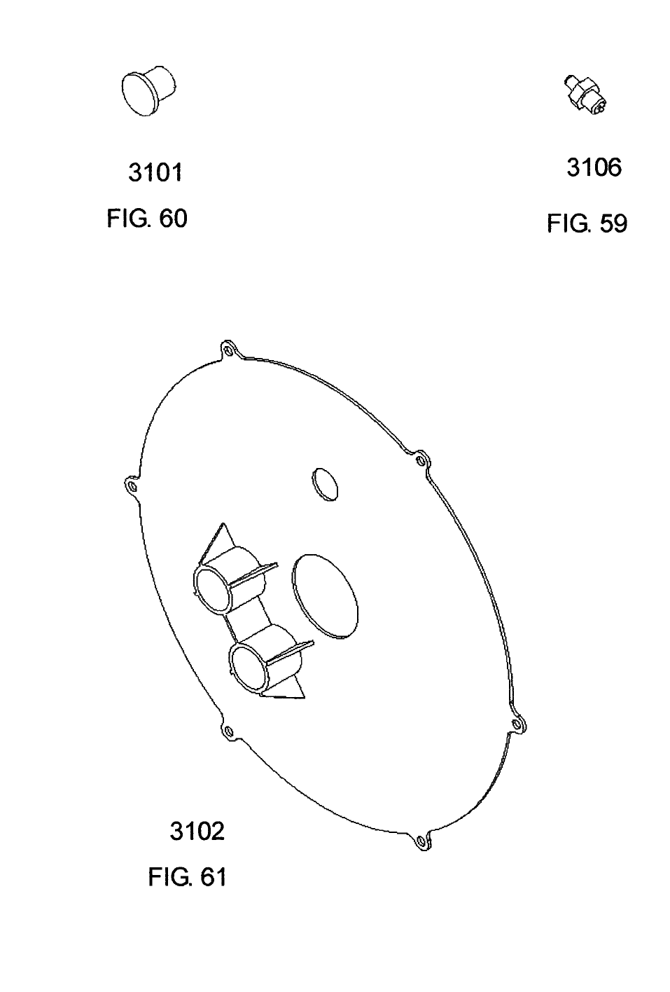

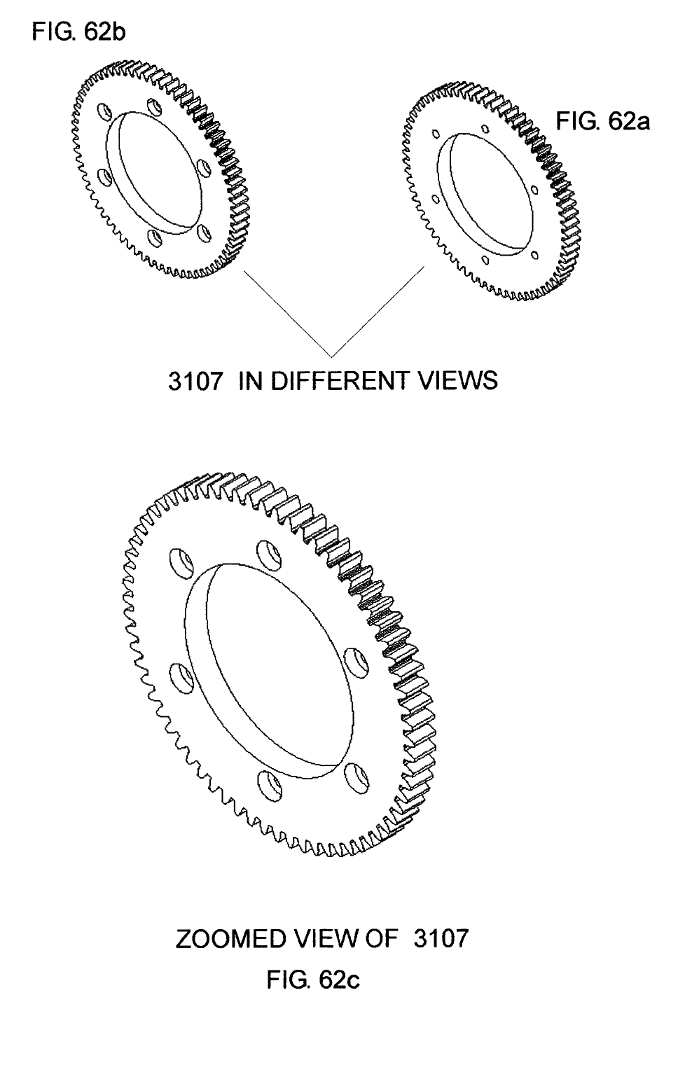

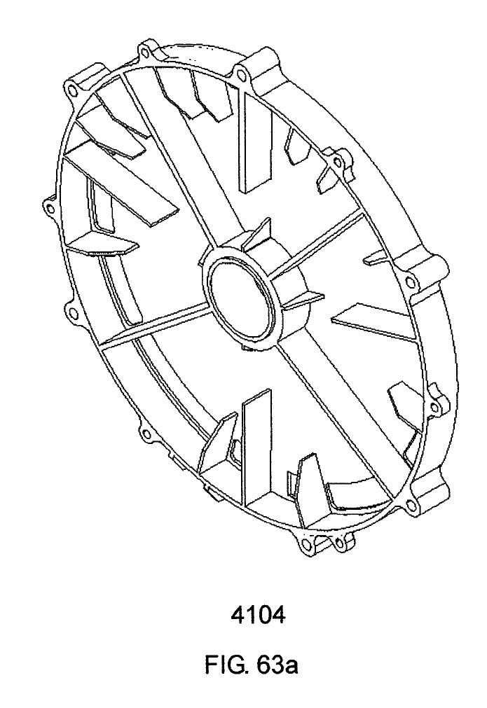

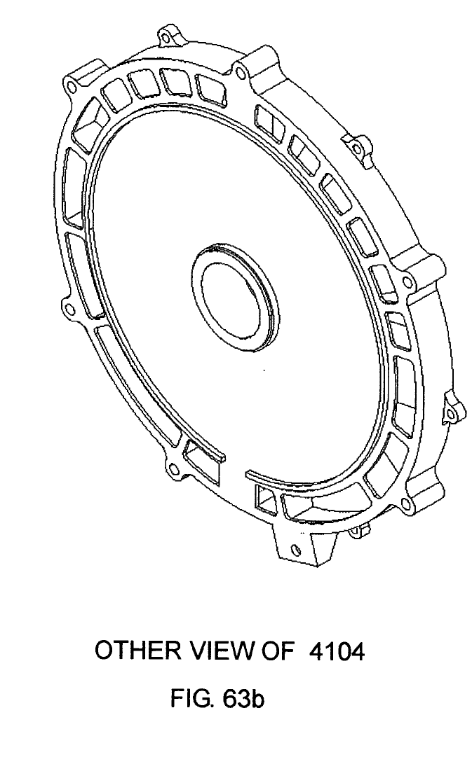

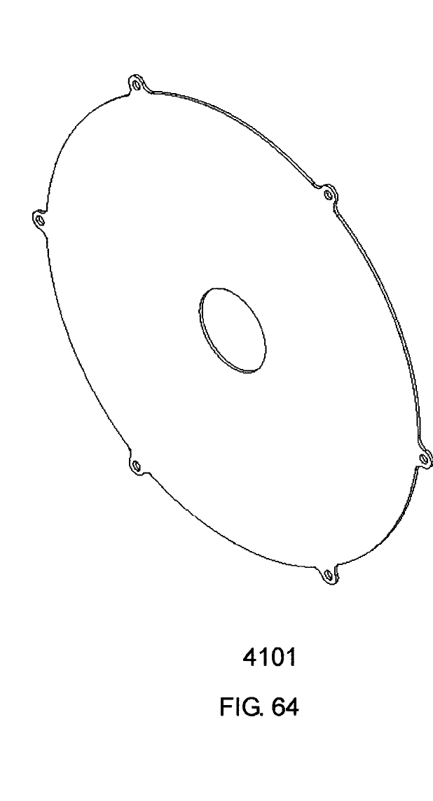

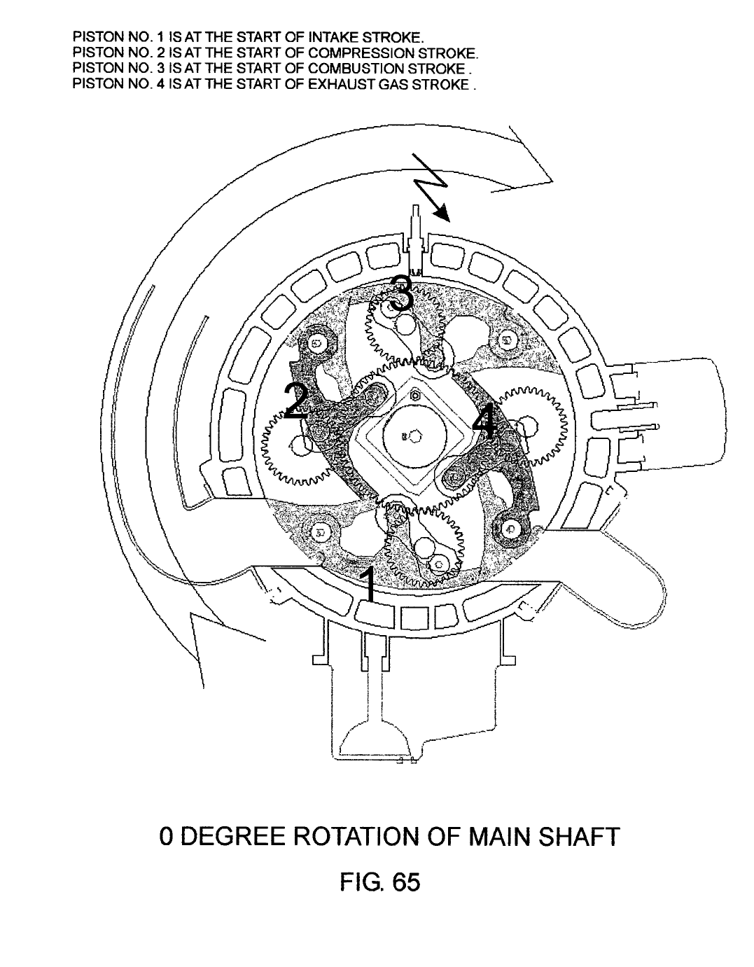

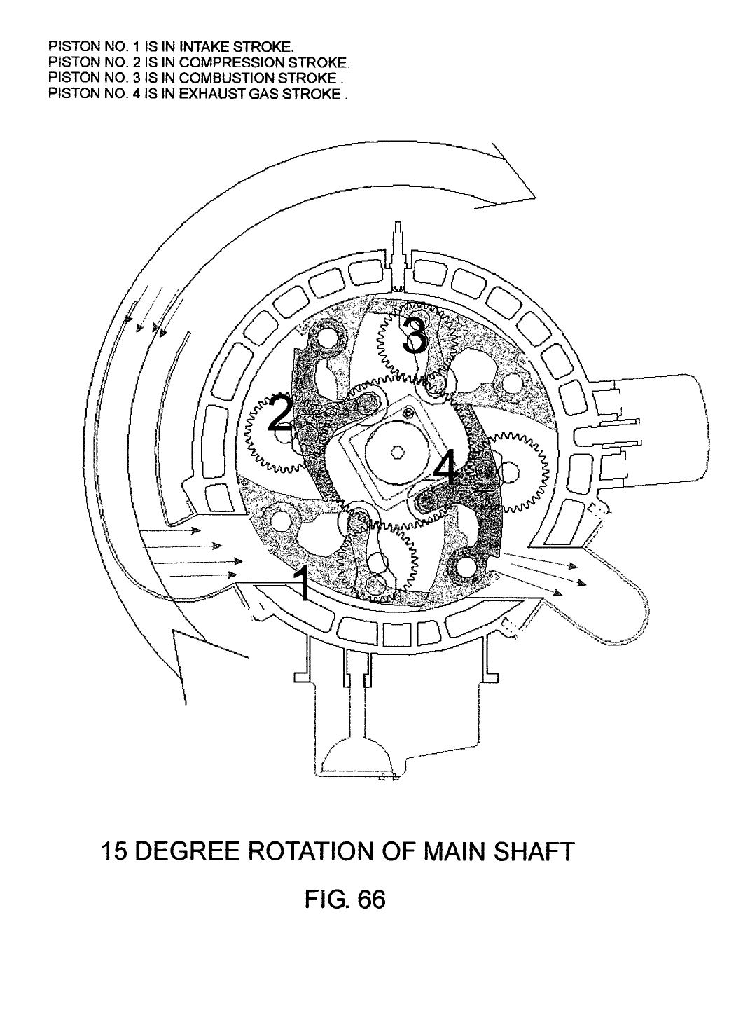

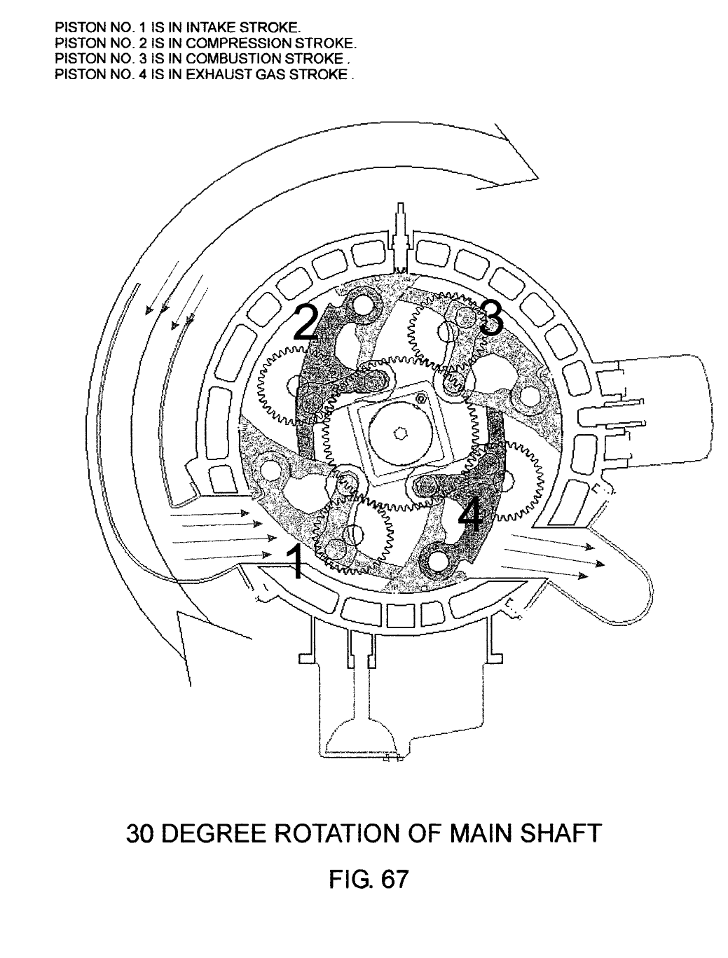

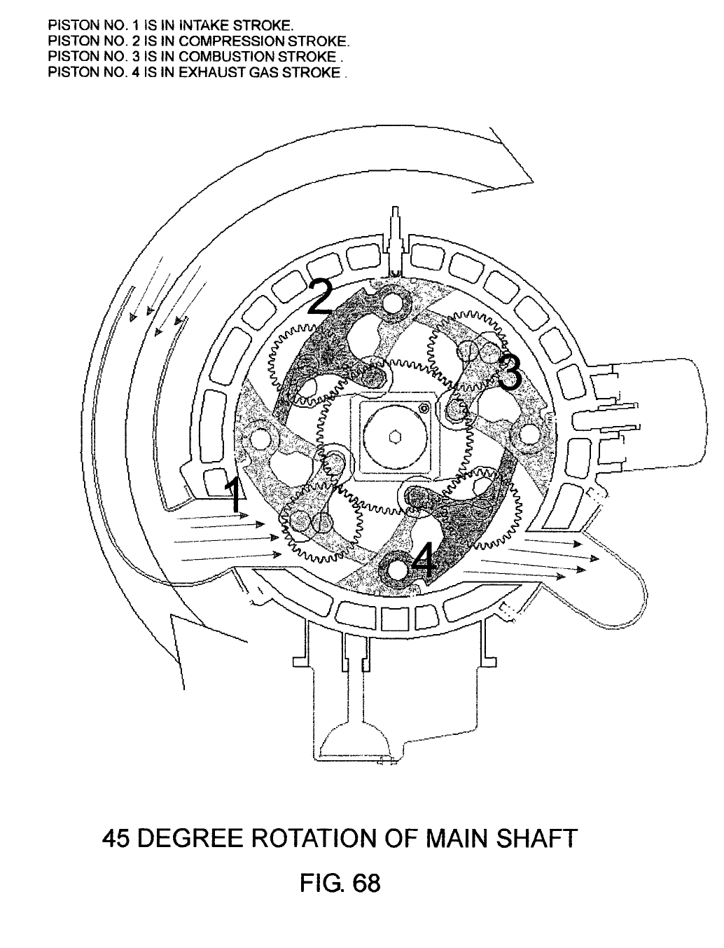

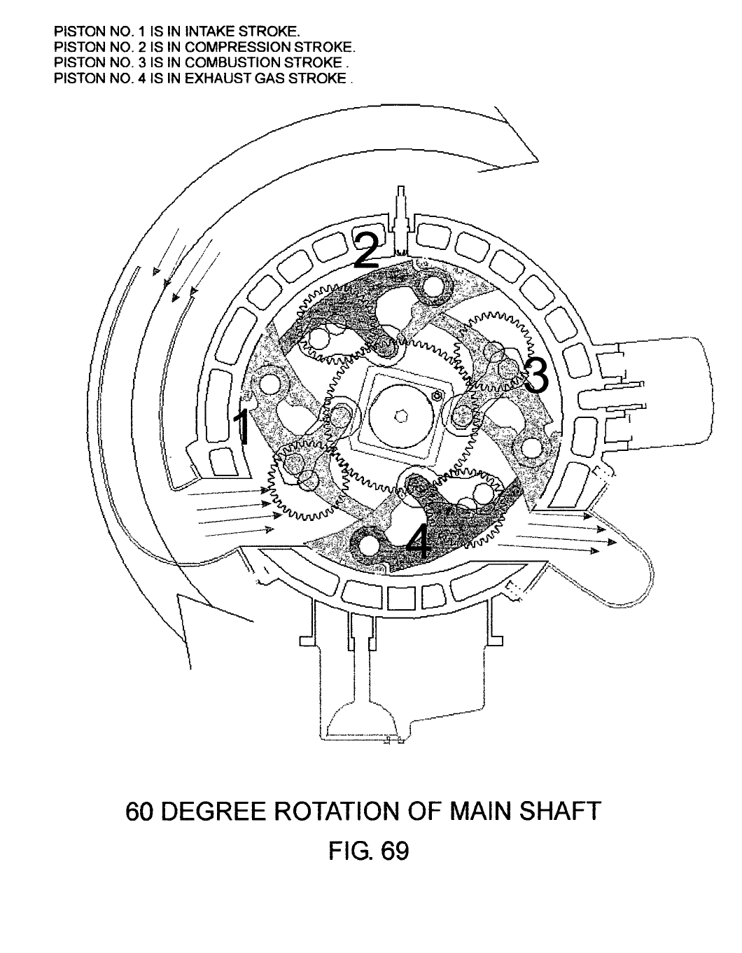

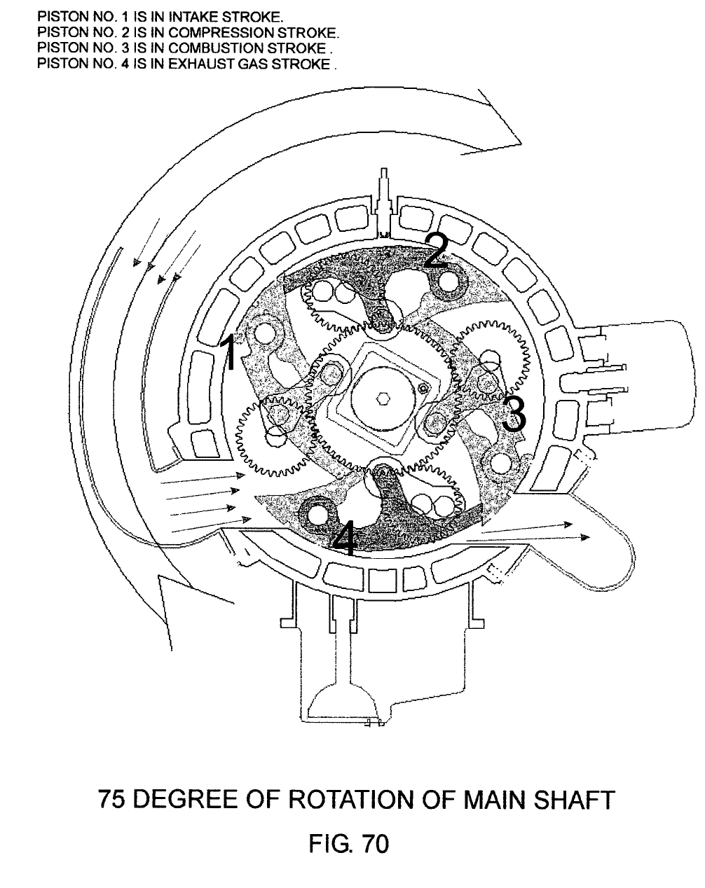

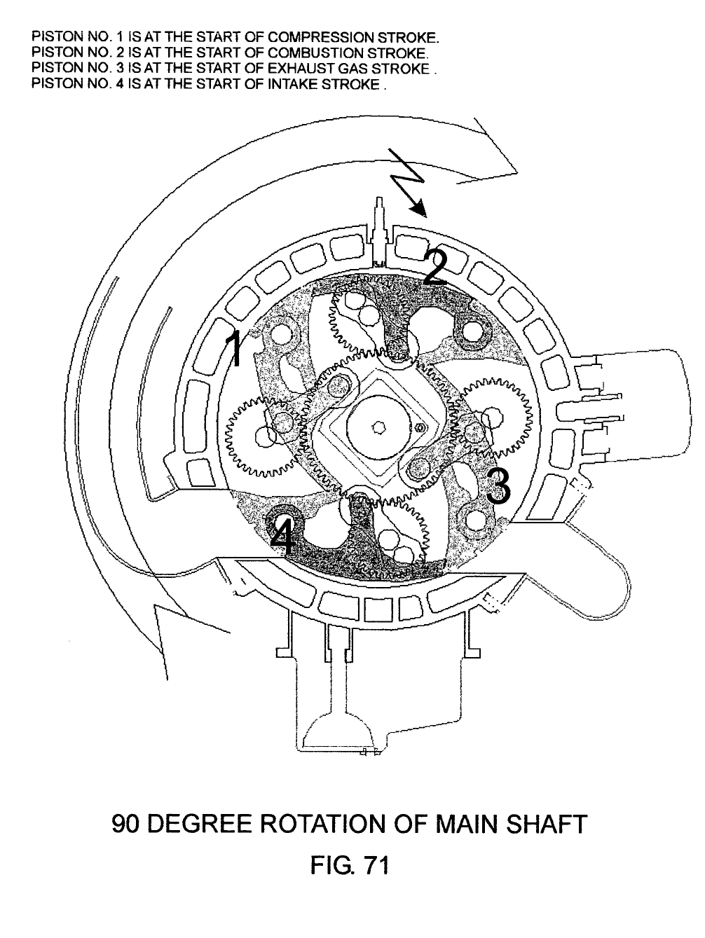

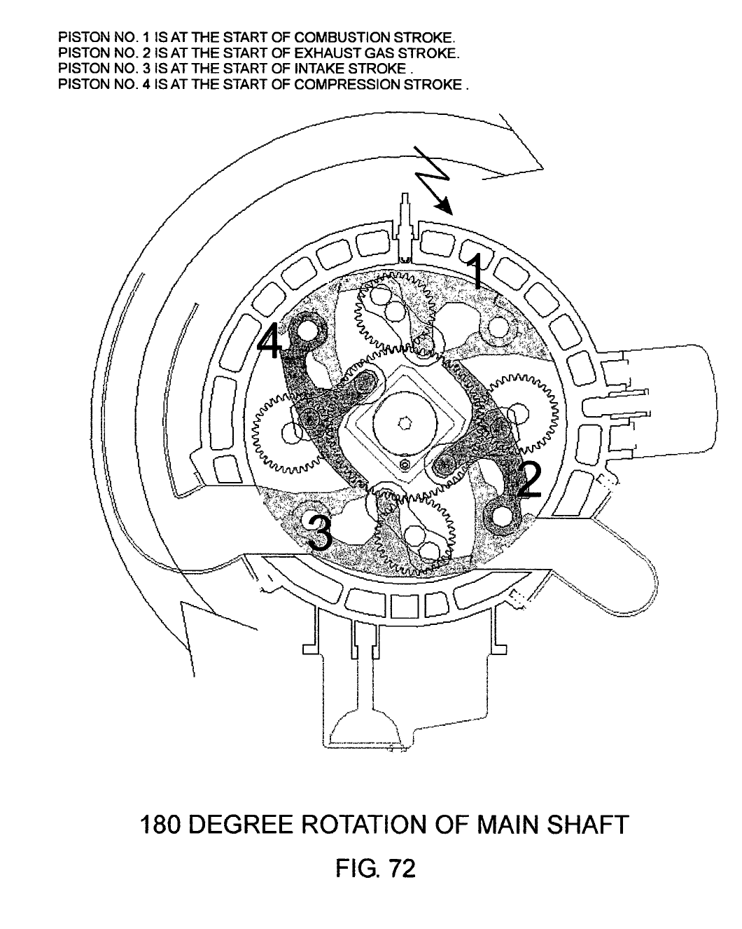

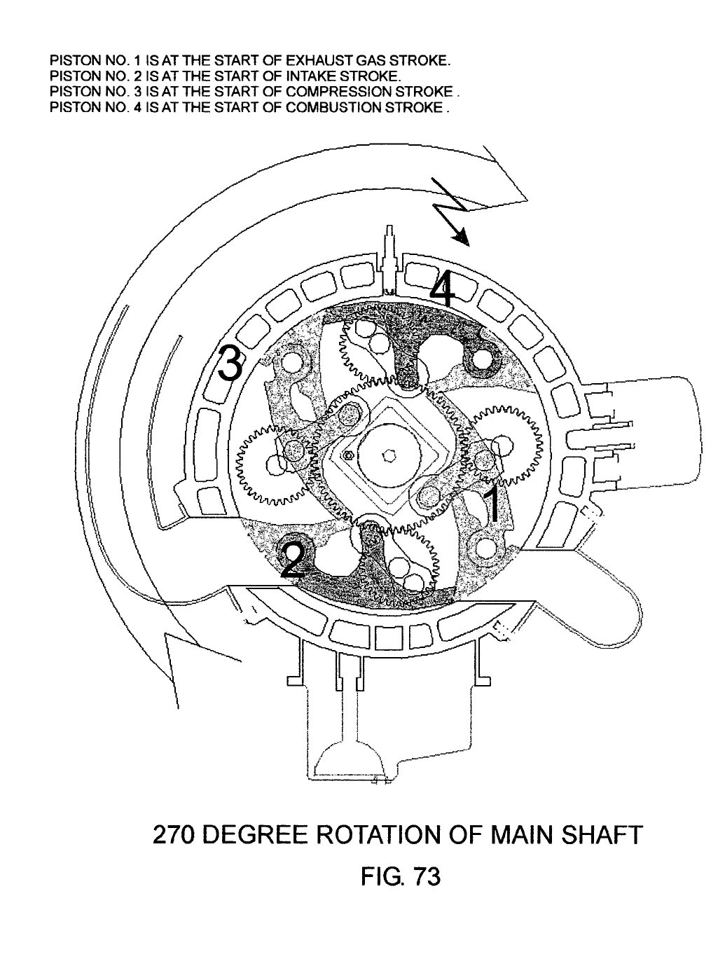

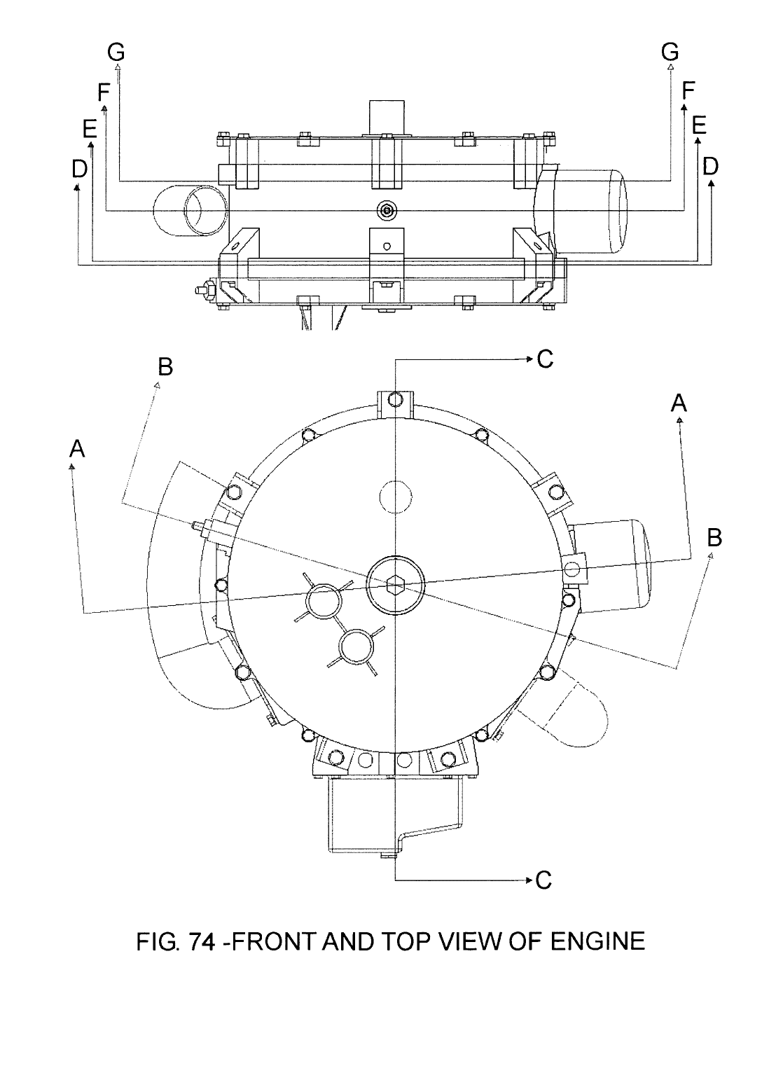

### DETAILED DESCRIPTION OF PREFERED EMBODIMENTS

Rotor assembly 1000 further comprises: chamber subassembly 1100, planet gear subassembly 1200 and shaft subassembly 1300.

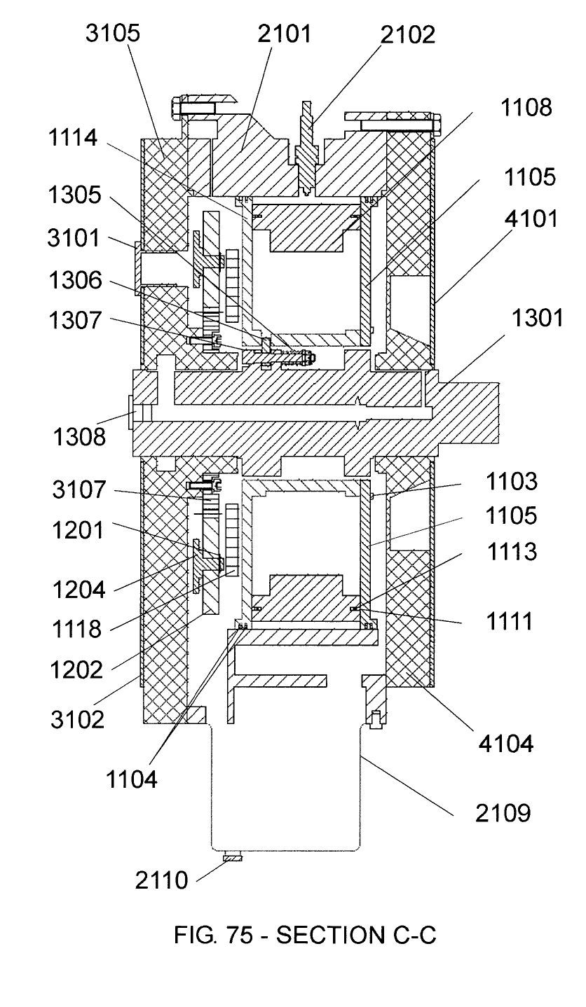

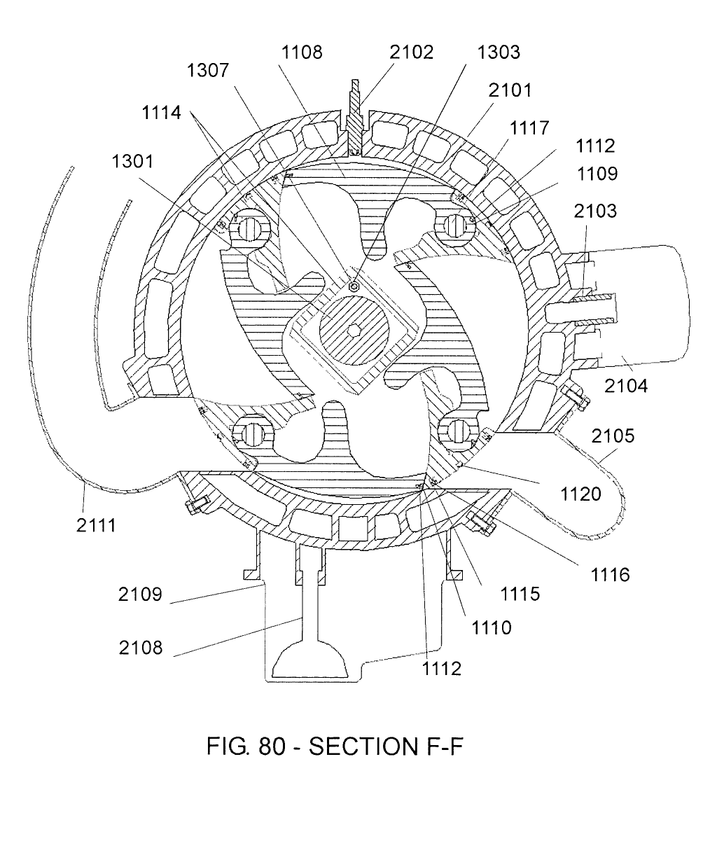

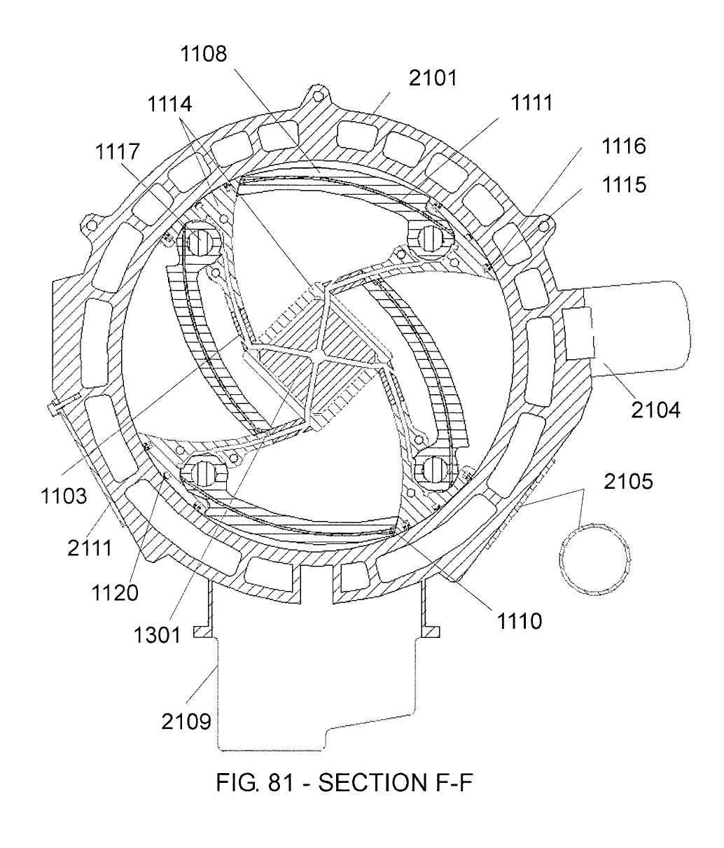

Shaft subassembly 1300 comprises: main shaft 1301 (rotor shaft), lubrication hole obturator 1308 and a lock mechanism including cotter pin 1302 slotted nut 1303 washer 1304 spring 1305 lock tongue 1306 and lock lever 1307 in order to lock chamber subassembly from moving along the shaft axis (refer to FIGS. 75 and 80). The main shaft has one main radial hole to receive oil from LH end cover assembly 3000 (refer to FIG. 75) There is a small longitudinal groove at the place of this hole on the outer surface of the shaft to lubricate the shaft bearing. The oil enters a longitudinal hole at the center of the shaft and goes for five radial holes of which one is for the lubrication of the shaft bearing at RH end cover assembly 4000 and the other four are for supplying oil to chamber subassembly 1100 (refer to FIG. 81).

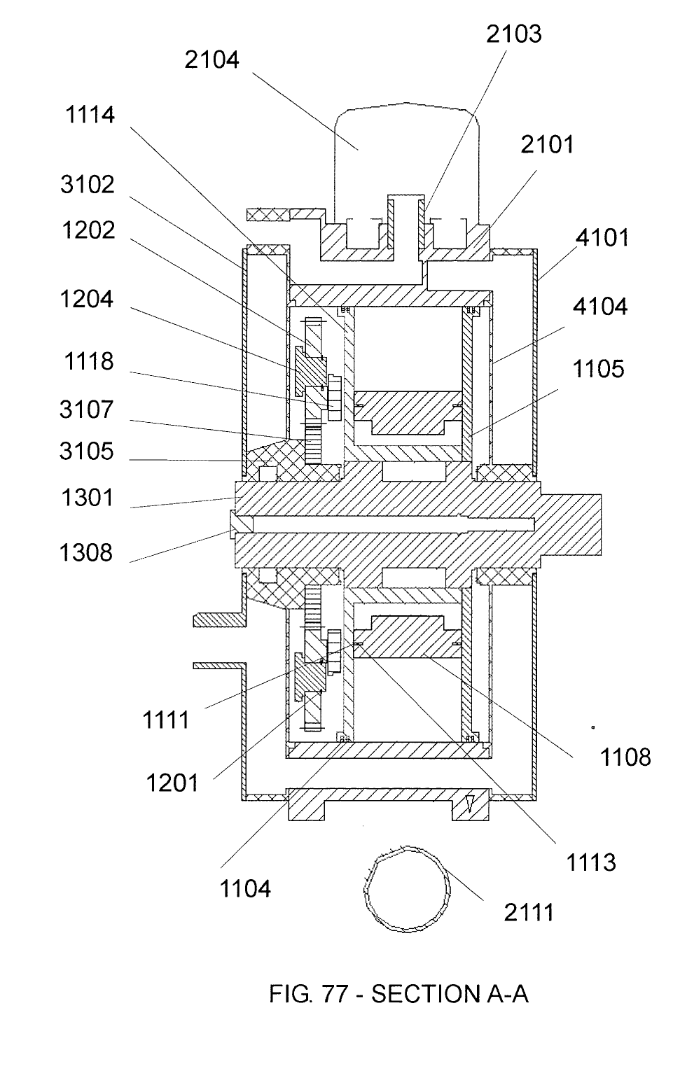

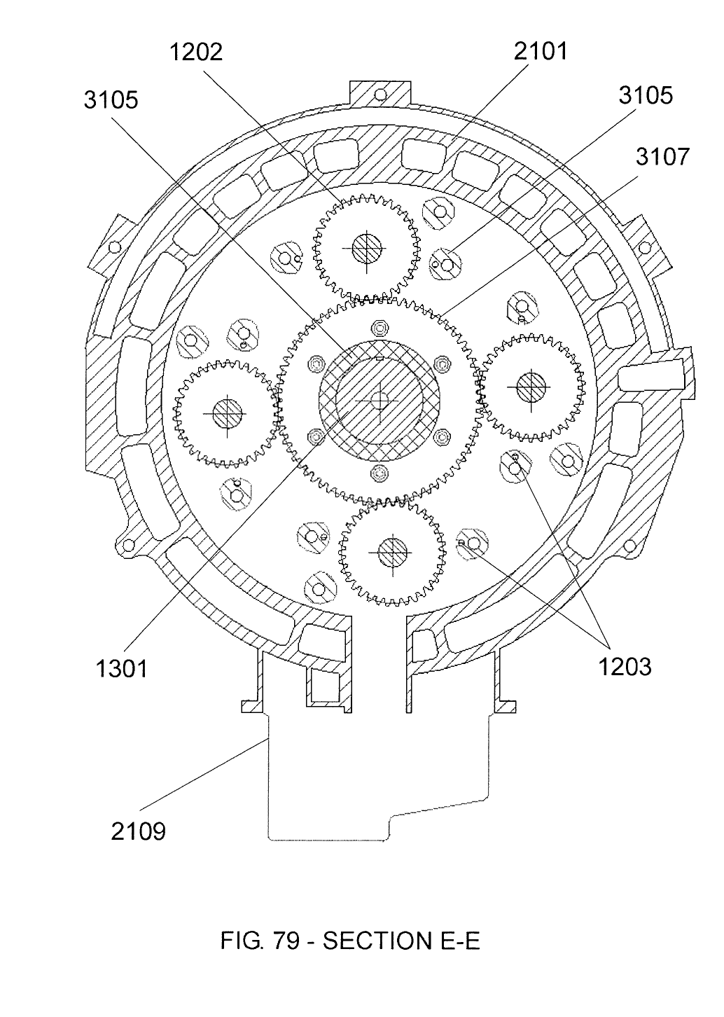

Planet gear subassembly 1200 comprises: planet gear 1202 mounted on a small shaft which is part of planet gear support 1204 by using a retaining ring 1201. All the gear subassemblies are located precisely on LH chamber side 1114 by using planet gear support locator pins 1203 (refer to FIG. 79) and then mounted securely. Gears 1202 are meshed with a sun gear 3107 on LH end cover assembly 3000 (refer to FIGS. 77 and 79).

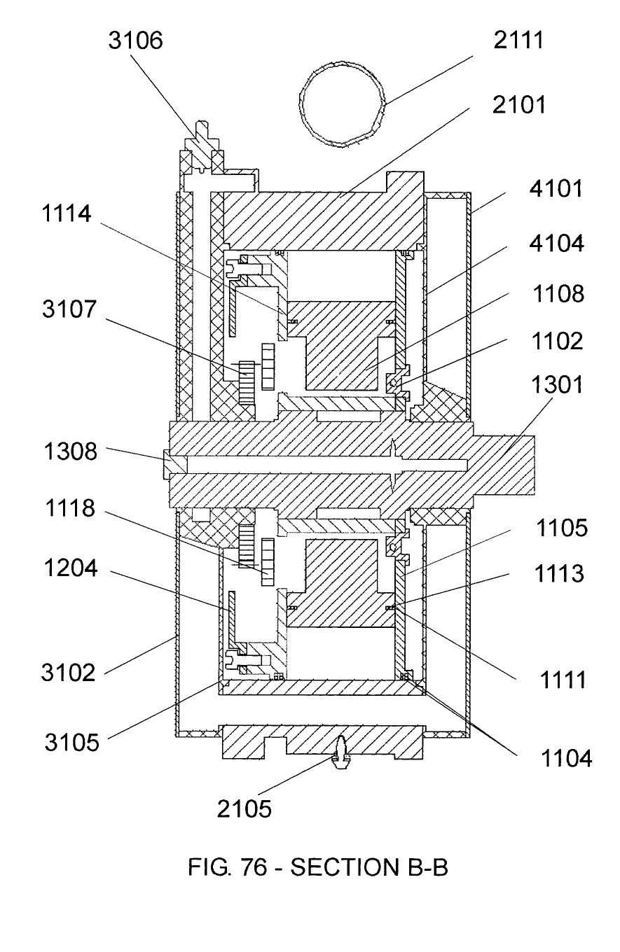

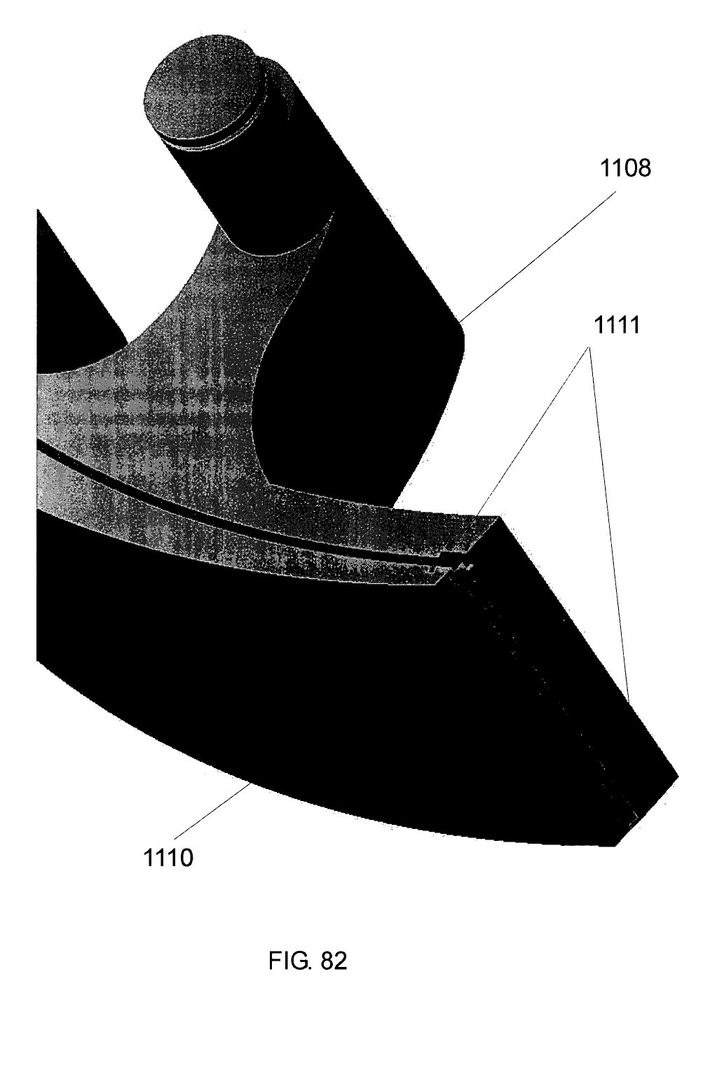

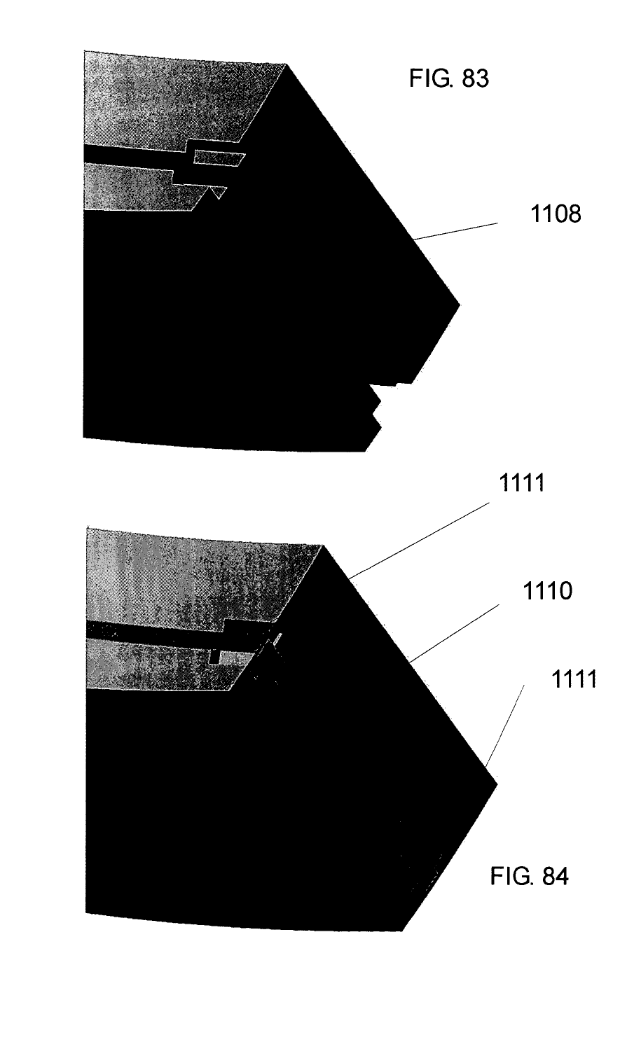

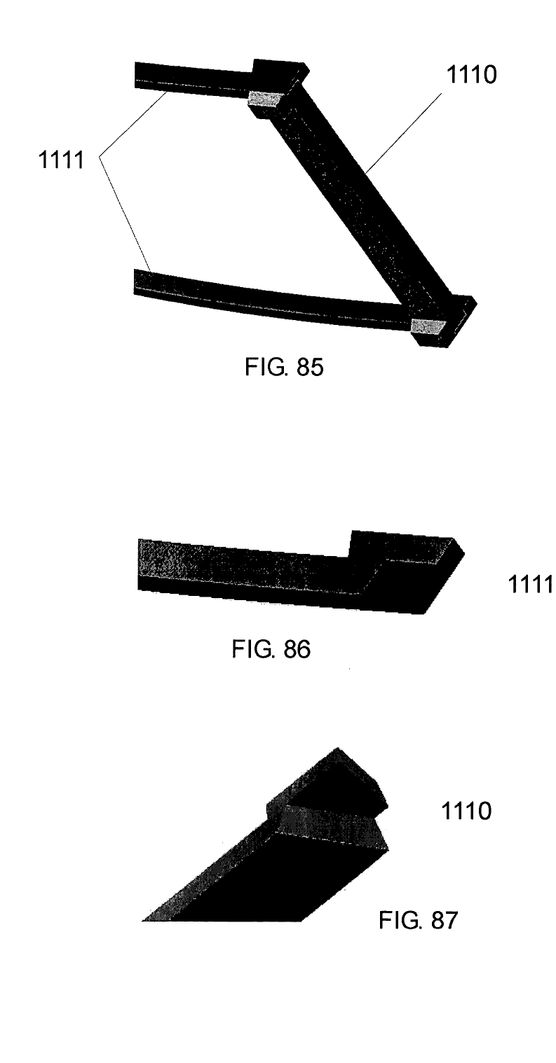

Chamber subassembly 1100 comprises: four pistons 1108 and their related seals and springs named piston rear seals 1109 piston front seals 1110, piston side seals 1111, piston RR & FR seal springs 1112 and piston side seal springs 1113 (all these seals are used to prevent gas leakage; FIGS. 82 to 87 show how front seal 1110 and piston side seal 1111 provide sealing at the place where these seals meet each other, and hence no corner seal is required), four piston pins 1117 as piston rotation axes, four piston pin retaining rings 1102 in order to keep piston pins 1117 in their positions, LH chamber side 1114, RH chamber side 1105 (these two parts are securely mounted to each other to form a number of chambers; there are openings on the circular face of the chamber sides (Nos. 1114 and 1105) for oil to leave the rotor and return to the oil tank (refer to FIGS. 75, 76 and 79) after lubricating those chamber inner surfaces that are in touch with pistons 1108 located inside the chamber), four oil bridges 1103 which are part of the oil path for chamber lubrication (refer to FIGS. 76 and 81) and press fitted on RH chamber side 1105, four parts called “oil flow limiters 1120” (refer to FIG. 80) each mounted on the outer surface of the LH chamber side between two adjacent piston chambers, each limiter being made of two major materials: a metal, acting as the structure for this component and a material capable of letting oil to flow through it to lubricate the inner surface of casing 2101 in a controlled manner, four piston rods 1118 that connect pistons 1108 to planet gear subassembly 1200 so as to synchronize the rotation of planet gears 1202 and pistons 1108, piston rod retaining rings 1119 used to secure rods 1118 to pistons 1108; circular seals 1104, transverse seals 1115, seal springs 1116(for transverse seals 1115), corner seals 1106 and corner seal springs 1107 mounted in recesses on the outer surface of the chamber; a corner seal is used where transverse seals 1115 and circular seals 1104 meet each other, there are some recesses on LH chamber side 1114 and square holes that are formed when RH chamber side 1105 is mounted on the recesses of LH chamber side 1114. These holes receive oil from the four aforementioned holes on shaft 1301 and oil flows to desired areas for lubrication (namely the inner chamber walls, piston pins 1117 and piston surfaces in touch with the chamber and outer surface of rotor 1000 where it touches the inner surface of casing 2101).

RH end cover assembly 4000 comprises: RH end cover 4104 and RH end cover plate 4101 which is mounted securely on RH end cover 4104. There are some radially positioned walls inside the end cover that form separate closed areas when end plate 4101 is mounted on end cover 4104. Also there are some openings on end cover 4104 matching in position with the longitudinal holes of casing 2101. The cooling water flowing in through the longitudinal holes enters a closed area through the openings and then leaves this closed area for other casing holes through other openings Assembly 4000 also takes the load of rotor assembly 1000 at the bearing.

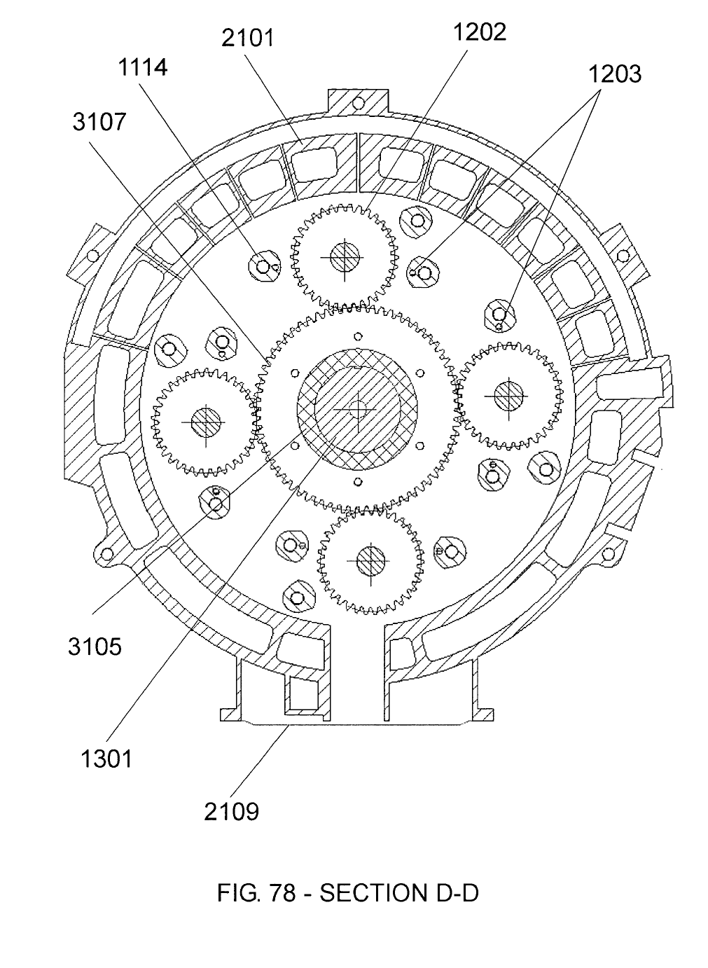

LH end cover assembly 3000 comprises: LH end cover 3105, LH end cover plate 3102 and sun gear 3107 where both plate 3102 and sun gear 3107 are mounted securely on LH end cover 3105, there are some walls inside cover 3105 with some openings on the cover with the same function as mentioned in the description of RH end cover assembly 4000. The inlet for the cold water coming from the radiator or the water pump (refer to FIG. 77) and the outlet for the warm water (flowing to the water pump) are located on LH end cover plate 3102. There is an outlet at the bottom of cover 3105 for flowing oil from oil tank 2109 on casing assembly 2000 to oil pump, an inlet again at the bottom of cover 3105 for returning the excess oil to oil tank 2109 on casing assembly 2000, also an inlet is located at nearly the top of cover 3105 for guiding the cooled oil (coming from the oil cooler or the oil pump) to the oil filter 2104 (refer to FIG. 77) on casing assembly 2000. There is an oil passage opening located nearly at the top of this cover (3105) to get the filtered oil from a duct on the casing (refer to FIGS. 76 and 78) where the oil comes in through the opening to a radially positioned hole on LH end cover 3105 (refer to FIG. 76) and goes for the lubrication of the bearing on cover 3105 (refer to FIG. 77) and for the radial hole on main shaft 1301 in order to lubricate the other parts of the engine (refer to FIG. 75). A proper hole for filling the oil tank has been considered near the top of assembly 3000 (refer to FIG. 75). The hole is covered with “oil refill hole cap 3101”. Also there is an oil pressure sensor 3106 on the top of cover 3105 right above the oil passage opening (refer to FIG. 76).

Casing assembly 2000 comprises: casing 2101, spark plug 2102, oil filter 2104, oil filter adapter 2103, oil tank 2109, oil tank strainer 2108, exhaust gas outlet 2105 and air-fuel mixture inlet 2111. There are many longitudinal holes on casing 2101 for flowing cooling water, also there are many radially positioned holes (refer to FIGS. 75 and 78) on the top of the inner surface of casing 2101 close to LH end cover 3105 for the lubrication of planet gears 1202 and sun gear 3107. The mentioned holes get the filtered oil from a duct on the top of the casing where the filtered oil directly enters after coming out of oil filter 2104. This duct also supplies oil to LH end cover assembly 3000. The oil in the casing returns to the oil tank via an opening on each side of the casing at the bottom (refer to FIGS. 75 and 79). There are three holes on casing 2101 matching the holes on LH end cover assembly 3000 (i.e. oil outlet and excess oil inlet at the bottom and oil inlet nearly at the top). The exhaust outlet 2105 and air-fuel mixture inlet 2111, oil tank 2109 and strainer 2108 are all mounted on casing 2101, oil filter 2104 is mounted on casing 2101 using a conventional adaptor called oil filter adaptor 2103. Both RH end cover assembly 4000 and LH end cover assembly 3000 are fixed to casing 2101. Eight fixing holes (four on each side) are considered near the middle of casing 2101 for fixing the engine to its support Also a suitable bolt called “oil tank drain bolt 2110” is positioned at the bottom of oil tank 2109 to drain the used oil (refer to FIG. 75).

1. An internal combustion rotary engine comprising: a casing forming a cylindrical chamber and having a number of holes and ducts as part of the cooling- and the lubrication systems, end covers that support the main engine shaft and are securely fixed on the sides of the casing, a rotor as a means for delivering power including piston chambers (replacing cylinders in conventional engines), rotationally reciprocating pistons in piston chambers to convert the expansion of combustion gas to rotational motion, piston pins allowing pistons to rotate around the pin axes, planet gears mounted on one or both side(s) of the rotor by fixing supports and piston rods that synchronize the rotation of both the pistons and the said planet gears where the planet gears are meshed with a sun gear(s) fixed on one or both side(s) of the casing on the engine block and the rotation of the planet gears around their own axes at the combustion stroke causes them to move on the sun gear(s) and causes the said rotor to rotate around the main shaft axis.

2. An internal combustion rotary engine as defined in claim 1, wherein there is(are) a circular seal(s) at each side of the outer surface of the rotor and there is(are) a straight transverse seal(s) close to the edge of the piston chambers on the outer surface of the rotors preventing gas leakage, also there are four seals on each piston (one seal on each contacting side of the piston) for gas sealing and ports on the casing for each engine block as air-fuel mixture intake port(s) and exhaust gas outlet port(s); spark plug(s) is(are) located on the casing and will initiate the ignition of compressed air-fuel mixture. In diesel type of this engine, fuel injector(s) replaces the spark plug(s).

3. An internal combustion rotary engine as defined in claim 1, wherein the cooling system of the engine comprises: two end covers for each engine block, mounted on the sides of the casing, their end plates and longitudinal holes passing through the casing; the lubrication system also acts as a cooling system and is introduced in claim no. 4; the cooling water from the radiator or the water pump enters the water inlet port on one of the end plates, then enters a closed area formed by the end plate and the end cover inner walls and flows to the closed area at the other side of the casing by passing through the said longitudinal holes in casing, and then flows into another closed area on the first side; water flows several times to the second end cover (in to a different closed area) and back again to the first end cover (in to a different closed area) and finally flows to the last closed area in the first end cover and leaves the engine through an outlet port and heads for the water pump.

4. An internal combustion rotary engine as defined in claim 1, wherein the lubrication system comprises: an oil-tank as the oil reservoir, a strainer, a duct at the bottom of the casing in order for oil to flow from the strainer to the outlet for the oil pump, an inlet port on one of the end covers with its related duct on the casing in order for the excess oil to return to the oil tank, an inlet port on the end cover to receive oil from the oil pump or the oil cooler in order for oil to flow to the oil filter seated on the casing; oil comes out through the oil filter, entering a duct in the casing at the top which has many small holes through the inner surface of the casing for the lubrication of the gears; and the remaining oil in the duct enters a second duct in one of the end covers; this oil goes for the lubrication of the rotor, the shaft bearing and the inner surface of the casing where it is in touch with the rotor; oil reaches the rotor shaft at the bearing through the second duct and enters the hole in the shaft; also there is a groove on the shaft at each bearing position for lubrication; the oil in the shaft hole flows through several smaller radially located holes and goes for the piston chambers and the other shaft bearing; the oil in those holes provided for the lubrication of the piston chambers passes through components called “oil bridge” that includes two small outlet ports, one nozzle-shaped hole in order for oil to enter the piston chamber area to lubricate the chamber and the piston; the remaining oil flows through the second hole to a duct in the rotor which goes for the lubrication of the cylindrical area of the piston and its corresponding surface of the chamber; then the oil leaves the rotor through a small hole to lubricate the outer surface of the rotor and the inner surface of the casing using an oil flow limiter through which oil passes in a controlled manner and from whose sides the excess oil can come out; also there are holes on rotor sides to lead oil out of the chamber after lubricating the chamber and the pistons. After lubrication, oil in the casing flows to the oil tank via openings at the bottom of the casing on both sides.

5. An internal combustion rotary engine as defined in claim 1, wherein the shape of the piston end profile could be adjusted in order to achieve a desired compression ratio; these parameters and the position of the spark plug(s) affect the performance of the mixture combustion.

6. An internal combustion rotary engine as defined in claim 1, wherein the rotor can rotate in just one direction; to identify the direction of rotation, the hinged connection of a planet gear and piston rod should not cross the imaginary line connecting the center of the planet gear and the center of the sun gear at combustion stroke.

7. An internal combustion rotary engine as defined in claim 1, wherein a lock mechanism mounted on the rotor shaft will prevent the rotor from moving along the shaft; the mechanism comprises: a lever, a tongue, a spring, a washer, a slotted hex nut and a cotter pin; to lock the rotor, the lever is pulled and rotated CW (CCW), then pushed to its rest position; to release the rotor, the lever is pulled, rotated in opposite direction, CCW (CW), and finally pushed; at the time of locking, the tongue will go through a hole in the rotor.

8. An internal combustion rotary engine as defined in claim 1, wherein to improve the gas sealing of the front area of the piston where the two seals meet each other, the ends of the seals are shaped so that they cover each other in this area and provide an air-tight sealing.

9. An internal combustion rotary engine as defined in claim 1, wherein the corner seals are used where circular seals and transverse seals meet each other on the outer surface of the rotor.

10. An internal combustion rotary engine as defined in claim 1, wherein the air-fuel intake stroke and the exhaust stroke can not overlap at any time unless it is part of the design requirements.

11. An internal combustion rotary engine as defined in claim 1, wherein the piston rod is under tension in combustion, exhaust and compression strokes and is under compression only in the intake stroke.

12. An internal combustion rotary engine as defined in claim 1, wherein the engine comprises a plurality of engine blocks.

13. An internal combustion rotary engine as defined in claim 1, wherein each engine block consisting of a rotor and its related casing and end covers.

14. An internal combustion rotary engine as defined in claim 1, wherein the number of complete working strokes (one working stoke comprises intake stroke, compression stroke, combustion stroke and exhaust stroke) per revolution of the main shaft for each piston is n where n can be 1,2,3, . . . and the value of n is unique for an engine block.

15. An internal combustion rotary engine as defined in claim 1, wherein the number of pistons in each engine block is equal to 4*n.

16. An internal combustion rotary engine as defined in claim 1, wherein the gear teeth ratio of the sun gear to the planet gear is expressed as 2*n.

17. A compressor comprising: a casing forming a cylindrical chamber and having a number of holes and ducts as part of the cooling- and the lubrication systems, end covers that support the main compressor shaft and are securely fixed on the sides of the casing, a rotor as a means for receiving power including piston chambers (replacing cylinders in conventional compressors), rotationally reciprocating pistons in piston chambers to intake and compress the fluid, piston pins allowing pistons to rotate around the pin axes, planet gears mounted on the rotor by fixing supports and piston rods that synchronize the rotation of both the pistons and the said planet gears; the planet gears are meshed with a sun gear(s) fixed on the compressor block; the rotation of the input shaft causes planet gears to rotate around their own axes and causes the pistons to reciprocate rotationally.

18. A compressor as defined in claim 17, wherein there is(are) a circular seal(s) at each side of the outer surface of the rotor and there is(are) a straight transverse seal(s) close to the edge of the piston chamber(s) on the outer surface of the rotor, preventing fluid leakage; also there are four seals on each piston (one seal on each contacting side of the piston) for sealing and there are ports on the casing for each compressor block as fluid intake port(s) and compressed-fluid exhaust port(s).

19. A compressor as defined in claim 17 comprising a plurality of compressor blocks with each compressor block consisting of a rotor and its related casing and end covers.
